(19) United States
(12) Patent Application Publication
(10) Pub. No.: US 2025/0060558 A1
(43) Pub. Date: Feb. 20, 2025

(54) OPTICAL IMAGE CAPTURING LENS

(71) Applicant: Ability Opto-Electronics Technology Co., Ltd., Taichung City (TW)

(72) Inventors: Ya-Ting Yang, Taichung City (TW); Chien-Hsun Lai, Taichung City (TW)

(73) Assignee: Ability Opto-Electronics Technology Co., Ltd., Taichung City (TW)

(21) Appl. No.: 18/603,712

(22) Filed: Mar. 13, 2024

Related U.S. Application Data
(60) Provisional application No. 63/520,338, filed on Aug. 17, 2023.
(60) Provisional application No. 63/541,554, filed on Sep. 29, 2023.

(51) Int. Cl. G02B 7/02

(52) U.S. Cl. CPC G02B 7/026; G02B 7/021

(57) ABSTRACT

An optical image capturing lens includes a first lens positioning unit, an imaging lens assembly, and a light entrance member. An interior of the first lens positioning unit is hollow, and the first lens positioning unit is made of an opaque material. The imaging lens assembly is installed within the first lens positioning unit. The imaging lens assembly includes a lens and an image plane. The lens defines a maximum effective diameter at an optical effective area. The light entrance member is made of an opaque material and installed within the first lens positioning unit. The light entrance member surrounds an optical axis. The light entrance member has a light entrance hole facing the first optical effective area of the lens to allow the optical axis to pass through, wherein a diameter of the light entrance hole is smaller than or equal to the maximum effective diameter of the lens.

### BACKGROUND OF THE INVENTION

### Technical Field

The present invention relates generally to an optical system; and more particularly to an optical image capturing lens.

### Description of Related Art

In recent years, with the rise of portable electronic devices having camera functionalities, the demand for an optical image capturing system is raised gradually. The image sensing device of ordinary photographing camera is commonly selected from charge coupled device (CCD) or complementary metal-oxide semiconductor sensor (CMOS Sensor). In addition, as advanced semiconductor manufacturing technology enables the minimization of pixel size of the image sensing device, the development of the optical image capturing system directs towards the field of high pixels. Therefore, the requirement for high imaging quality is rapidly raised.

Traditional lens assembly structures use a lens barrel to fix relative positions of lenses and to serve as a component to block non-imaging light. However, with the continuous advancement in pixel enhancement and miniaturization of portable electronic devices, the demand and development trend of optical systems lean towards high pixel quality. Nevertheless, conventional optical systems lack shading capabilities, and an opaque component is not provided within the lens barrel thus failing to meet the high pixel imaging quality requirements of optical systems.

### BRIEF SUMMARY OF THE INVENTION

In view of the above, the primary objective of the present invention is to provide an optical image capturing lens, wherein a light entrance member, which is opaque, is disposed in the optical image capturing lens, so that a non-imaging light could be effectively blocked from passing through a lens, thus correspondingly enhancing imaging quality.

The present invention provides an optical image capturing lens including a first lens positioning unit, an imaging lens assembly, and at least one light entrance member. An interior of the first lens positioning unit is hollow, and the first lens positioning unit is made of an opaque material. One end of the first lens positioning unit has an object-side opening communicating with the interior of the first lens positioning unit. The imaging lens assembly is installed within the first lens positioning unit. The imaging lens assembly, along an optical axis from an object side to an image side starting from the object-side opening, includes at least one lens and an image plane. The at least one lens has refractive power. The at least one lens has an optical effective area and an optical ineffective area, wherein the optical effective area is surrounded by the optical ineffective area, and the optical axis passes through the at least one lens via the optical effective area. The at least one lens defines a maximum effective diameter at the optical effective area. The image plane is located on one side of the at least one lens opposite to the object-side opening. The at least one light entrance member is made of an opaque material, and the at least one light entrance member is installed within the first lens positioning unit and is disposed on either an object-side surface, which faces the object side, or an image-side surface, which faces the image side, of the at least one lens. The at least one light entrance member surrounds the optical axis and faces the optical ineffective area. The at least one light entrance member has a light entrance hole facing the optical effective area of the at least one lens to allow the optical axis to pass through, wherein a diameter of the light entrance hole is smaller than or equal to the maximum effective diameter of the at least one lens.

In an embodiment, the at least one light entrance member satisfies: 0 μm<TILE≤50 μm, wherein TILE is a thickness of an inner peripheral edge of the at least one light entrance member at the light entrance hole.

The present invention further provides an optical image capturing lens including a first lens positioning unit, an imaging lens assembly, and at least one light entrance member. An interior of the first lens positioning unit is hollow, and the first lens positioning unit is made of an opaque material. One end of the first lens positioning unit has an object-side opening. The imaging lens assembly is installed within the first lens positioning unit, wherein the imaging lens assembly, along an optical axis from an object side to an image side starting from the object-side opening, includes a first lens, a second lens, and an image plane. The first lens and the second lens each have refractive power. The first lens has a first optical effective area and a first optical ineffective area, wherein the first optical effective area is surrounded by the first optical ineffective area. The second lens has a second optical effective area and a second optical ineffective area, wherein the second optical effective area faces the first optical effective area, and the second optical effective area is surrounded by the second optical ineffective area. The image plane is located on one side of the second lens opposite to the object-side opening and the first lens. The optical axis passes through the first lens and the second lens respectively via the first optical effective area and the second optical effective area. The first lens defines a first maximum effective diameter at the first optical effective area, and the second lens defines a second maximum effective diameter at the second optical effective area. The at least one light entrance member is made of an opaque material and is installed within the first lens positioning unit. The at least one light entrance member surrounds the optical axis and is located between the first lens and second lens. The at least one light entrance member is disposed on a side of the first optical ineffective area of the first lens facing the second optical ineffective area of the second lens. The at least one light entrance member has a light entrance hole facing the first optical effective area and the second optical effective area to allow the optical axis to pass through, wherein a diameter of the light entrance hole is smaller than or equal to the first maximum effective diameter of the first lens and is smaller than or equal to the second maximum effective diameter of the second lens.

The advantage of the present invention lies in the optical image capturing lens effectively blocking the non-imaging light from entering the imaging lens assembly through the design of the at least one light entrance member, so that the interference from the non-imaging light is reduced, thus enhancing imaging quality. Moreover, the dimensions of each light entrance member are reduced by the TILE condition in the design of the light entrance members. This achieves the dual objectives of miniaturizing the optical image capturing lens and improving optical imaging quality.

### BRIEF DESCRIPTION OF THE SEVERAL VIEWS OF THE DRAWINGS

The present invention would be best understood by referring to the following detailed description of some illustrative embodiments in conjunction with the accompanying drawings, in which

FIG. 1 is a schematic view of the optical image capturing lens according to a first embodiment of the present invention;

FIG. 2 is a partially enlarged view of a marked region A in FIG. 1;

FIG. 3 is a partially enlarged view of the inner edge of the light entrance hole of the first light entrance member of the optical image capturing lens according to the first embodiment of the present invention;

FIG. 4A is a schematic view showing that the inner annular section of the first light entrance member of the optical image capturing lens is adjusted to the trapezoidal configuration along with the changes under the ALE conditions, according to the first embodiment of the present invention;

FIG. 4B is another schematic view showing that the inner annular section of the first light entrance member of the optical image capturing lens is adjusted to the trapezoidal configuration of the along with the changes under the ALE conditions, according to the first embodiment of the present invention;

FIG. 5A is a schematic view showing that the inner annular section of the first light entrance member of the optical image capturing lens is adjusted to the angular configuration along with the changes under the TILE conditions, according to the first embodiment of the present invention;

FIG. 5B is another schematic view showing that the inner annular section of the first light entrance member of the optical image capturing lens is adjusted to the trapezoidal configuration along with the changes under the TILE conditions, according to the first embodiment of the present invention;

FIG. 6A is a schematic view showing that the inner annular section of the first light entrance member of the optical image capturing lens is adjusted to the trapezoidal configuration along with the changes under the ALE conditions, according to the first embodiment of the present invention;

FIG. 6B is another schematic view showing that the inner annular section of the first light entrance member of the optical image capturing lens adjusted into the trapezoidal configuration along with the changes under the ALE conditions, according to the first embodiment of the present invention;

FIG. 7A is a schematic view showing that the inner annular section of the first light entrance member of the optical image capturing lens is adjusted to the angular configuration along with the changes under the TILE conditions, according to the first embodiment of the present invention;

FIG. 7B is another schematic view showing that the inner annular section of the first light entrance member of the optical image capturing lens is adjusted to the trapezoidal configuration along with the changes under the TILE conditions, according to the first embodiment of the present invention;

FIG. 8 is a schematic view showing that the inner annular section of the first light entrance member of the optical image capturing lens is adjusted into the tapered configuration, according to the first embodiment of the present invention;

FIG. 9A is a schematic view showing that the inner annular section of the first light entrance member of the optical image capturing lens is with the TILE condition set at 1.0 μm along with the OALE conditions and IALE changes, according to the first embodiment of the present invention;

FIG. 9B is a schematic view showing that the inner annular section of the first light entrance member of the optical image capturing lens is with the TILE condition set at 3.0 μm along with the OALE conditions and IALE changes, according to the first embodiment of the present invention;

FIG. 9C is a schematic view showing that the inner annular section of the first light entrance member of the optical image capturing lens is with the TILE condition set at 5.0 μm along with the OALE conditions and IALE changes, according to the first embodiment of the present invention;

FIG. 10A is a schematic view showing that the inner annular section of the first light entrance member of the optical image capturing lens is with the TILE condition set at 1.0 μm along with the OALE conditions and IALE changes, according to the first embodiment of the present invention;

FIG. 10B is a schematic view showing that the inner annular section of the first light entrance member of the optical image capturing lens is with the TILE condition set at 3.0 μm along with the OALE conditions and IALE changes, according to the first embodiment of the present invention;

FIG. 10C is a schematic view showing that the inner annular section of the first light entrance member of the optical image capturing lens is with the TILE condition set at 5.0 μm along with the OALE conditions and IALE changes, according to the first embodiment of the present invention;

FIG. 11 is a schematic view of the optical image capturing lens according to a second embodiment of the present invention;

FIG. 12 is a partially enlarged view of a marked region B in FIG. 11;

FIG. 13A is a schematic view of the optical image capturing lens according to the second embodiment of the present invention, showing that the TOLE condition of the first light entrance member is adjusted;

FIG. 13B is another schematic view of the optical image capturing lens according to the second embodiment of the present invention, showing the TOLE condition of the first light entrance member is adjusted;

FIG. 13C is still another schematic view of the optical image capturing lens according to the second embodiment of the present invention, showing the TOLE condition of the first light entrance member is adjusted;

FIG. 13D is still another schematic view of the optical image capturing lens according to the second embodiment of the present invention, showing the TOLE condition of the first light entrance member is adjusted;

FIG. 14A is a schematic view showing the light entrance central axis of the first light entrance hole, the opening central axis of the object-side opening, and the optical axis of the optical image capturing lens according to the second embodiment of the present invention;

FIG. 14B is another schematic view showing the light entrance central axis of the first light entrance hole, the opening central axis of the object-side opening, and the optical axis of the optical image capturing lens according to the second embodiment of the present invention;

FIG. 15 is a schematic view of the optical image capturing lens according to a third embodiment of the present invention;

FIG. 16 is a partially enlarged view of a marked region C in FIG. 15;

FIG. 17 is a schematic view of the optical image capturing lens according to a fourth embodiment of the present invention;

FIG. 18 is a schematic view of the optical image capturing lens according to a fifth embodiment of the present invention.

### DETAILED DESCRIPTION OF THE INVENTION

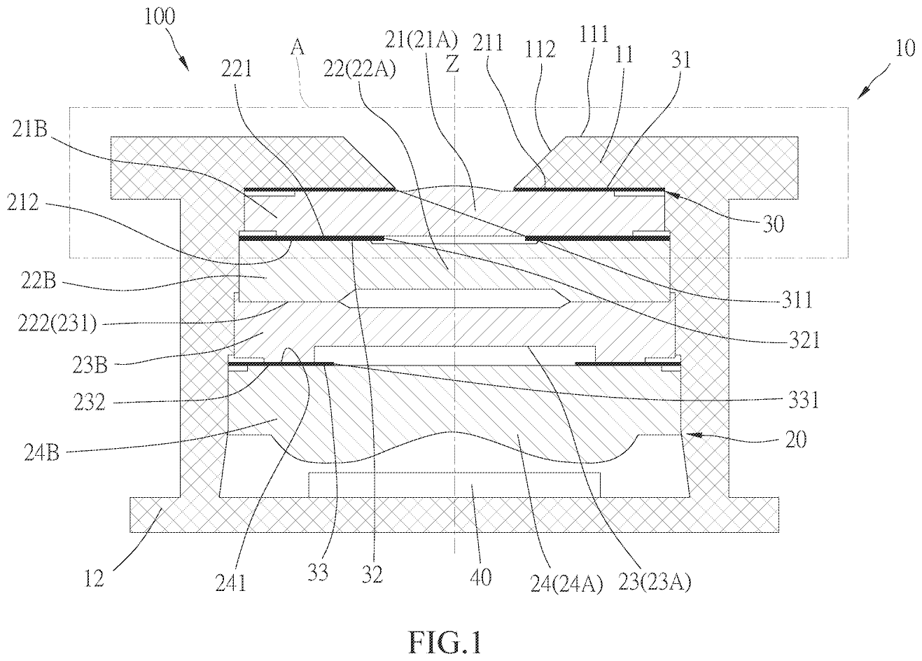

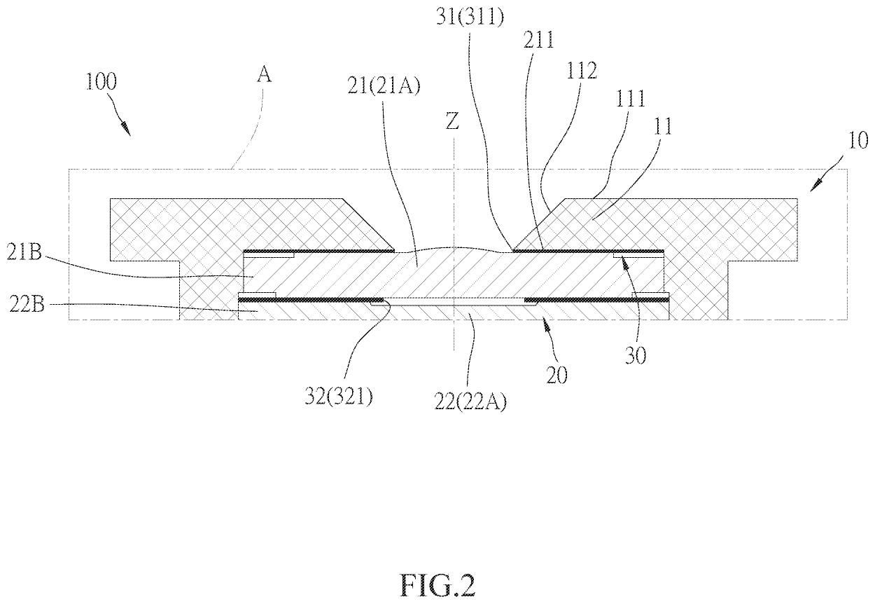

An optical image capturing lens 100 according to a first embodiment of the present invention is illustrated in FIG. 1 and FIG. 2 and includes a first lens positioning unit 10, an imaging lens assembly 20, and a plurality of light entrance members 30.

An interior of the first lens positioning unit 10 is hollow, and the first lens positioning unit 10 is made of an opaque material. In this embodiment, the first lens positioning unit 10 includes a lens barrel 11 and a lens holder 12 that are formed as an integrated structure. One end of the lens barrel 11 contracts radially inward to form a light blocking ring 111, wherein an inner edge of the light blocking ring 111 surrounds to form an object-side opening 112. The object-side opening 112 communicates with an interior of the lens barrel 11. The lens holder 12 is combined with another end of the lens barrel 11 opposite to the object-side opening 112. In other embodiments, the lens barrel 11 could be combined with or detached from the lens holder 12.

The imaging lens assembly 20 is installed within the lens barrel 11 of the first lens positioning unit 10. The imaging lens assembly 20, in order along an optical axis Z from an object side to an image side starting from the object-side opening 112, includes a first lens 21, a second lens 22, a third lens 23, a fourth lens 24, and an image plane (not shown). The first lens 21, the second lens 22, the third lens 23, and the fourth lens 24 each have refractive power and are arranged sequentially within the interior of the lens barrel 11. As shown in FIG. 2, the first lens 21 is located on an inner side of the light blocking ring 111, wherein an object-side surface 211, which faces the object side, of the first lens 21 is exposed to the object-side opening 112 of the lens barrel 11. The first lens 21 has a first optical effective area 21A and a first optical ineffective area 21B. The first optical effective area 21A is correspondingly exposed to the object-side opening 112, and the optical axis Z passes through the first optical effective area 21A. The first optical effective area 21A is surrounded by the first optical ineffective area 21B. The light blocking ring 111 faces the object-side surface 211 of the first lens 21 in correspondence to the first optical ineffective area 21B, and the light blocking ring 111 correspondingly blocks the first optical ineffective area 21B of the first lens 21. In this embodiment, the first optical effective area 21A denotes an area of the imaging lens assembly 20 correspondingly passed through by the optical axis Z and an imaging light. The first optical ineffective area 21B denotes an area that surrounds the optical axis Z of the imaging lens assembly 20 and is not passed through by the imaging light.

Additionally, the first lens 21 defines a first maximum effective diameter at the first optical effective area 21A. A definition of the first maximum effective diameter is exemplified by using the object-side surface 211 of the first lens 21. The optical axis Z passes through the first optical effective area 21A of the first lens 21. The optical axis Z intersects with the object-side surface 211 of the first lens 21 to form an intersection point. A distance from the intersection point to a maximum effective half diameter position in a direction perpendicular to the optical axis Z is defined as a maximum effective half diameter. The first maximum effective diameter is defined as twice the distance of the maximum effective half diameter of the first lens 21 and is perpendicular to the optical axis Z. The maximum effective half diameter position of the first lens 21 is defined as a very edge of the first optical effective area 21A being in contact with the first optical ineffective area 21B.

An object-side surface 221 of the second lens 22 faces an image-side surface 212 of the first lens 21. The second lens 22 has a second optical effective area 22A and a second optical ineffective area 22B. The second optical effective area 22A faces the first optical effective area 21A, and the optical axis Z passes through the second optical effective area 22A. The second optical effective area 22A is surrounded by the second optical ineffective area 22B, and the second optical ineffective area 22B correspondingly faces the first optical ineffective area 21B.

Furthermore, the second lens 22 defines a second maximum effective diameter at the second optical effective area 22A. A definition way of the second maximum effective diameter is the same as the definition way of the first maximum effective diameter. The optical axis Z passes through the second optical effective area 22A of the second lens 22, and the optical axis Z intersects with the object-side surface 221 of the second lens 22 to form an intersection point. A distance from the intersection point to a maximum effective half diameter position in the direction perpendicular to the optical axis Z is defined as a maximum effective half diameter. The second maximum effective diameter is defined as twice the distance of the maximum effective half diameter of the second lens 22 and is perpendicular to the optical axis Z. The maximum effective half diameter position of the second lens 22 is defined as a point of a very edge of the second optical effective area 22A being in contact with the second optical ineffective area 22B.

An object-side surface 231 of the third lens 23 faces an image-side surface 222 of the second lens 22. The third lens 23 has a third optical effective area 23A and a third optical ineffective area 23B. The third optical effective area 23A faces the second optical effective area 22A, and the optical axis Z passes through the third optical effective area 23A. The third optical effective area 23A is surrounded by the third optical ineffective area 23B, and the third optical ineffective area 23B abuts against the second optical ineffective area 22B. The third lens 23 defines a third maximum effective diameter at the third optical effective area 23A. The optical axis Z passes through the third optical effective area 23A of the third lens 23, and the optical axis Z intersects with the object-side surface 231 of the third lens 23 to form an intersection point. A distance from the intersection point to a maximum effective half diameter position in the direction perpendicular to the optical axis Z is defined as a maximum effective half diameter. The third maximum effective diameter is defined as twice the distance of the maximum effective half diameter of the third lens 23 and is perpendicular to the optical axis Z. The maximum effective half diameter position of the third lens 23 is defined as a point of a very edge of the third optical effective area 23A being in contact with the third optical ineffective area 23B.

An object-side surface 241 of the fourth lens 24 faces an image-side surface 232 of the third lens 23. The fourth lens 24 has a fourth optical effective area 24A and a fourth optical ineffective area 24B. The fourth optical effective area 24A faces the third optical effective area 23A, and the optical axis Z passes through the fourth optical effective area 24A. The fourth optical effective area 24A is surrounded by the fourth optical ineffective area 24B, and the fourth optical ineffective area 24B correspondingly faces the third optical ineffective area 23B. The fourth lens 24 defines a fourth maximum effective diameter at the fourth optical effective area 24A. The optical axis Z passes through the fourth optical effective area 24A of the fourth lens 24, and the optical axis Z intersects with the object-side surface 241 of the fourth lens 24 to form an intersection point. A distance from the intersection point to a maximum effective half diameter position in the direction perpendicular to the optical axis Z is defined as a maximum effective half diameter. The fourth maximum effective diameter is defined as twice the distance of the maximum effective half diameter of the fourth lens 24 and is perpendicular to the optical axis Z. The maximum effective half diameter position of the fourth lens 24 is defined as a very edge of the fourth optical effective area 24A being in contact with the fourth optical ineffective area 24B.

Each of the light entrance members 30 is made of an opaque material and is installed within the lens barrel 11 of the first lens positioning unit 10. The opaque material of the light entrance members 30 includes one of the following: metal, plastic, carbon, polyethylene terephthalate (PET), or polyimide (PI). In the first embodiment as shown in FIG. 1, the light entrance members 30 include a first light entrance member 31, a second light entrance member 32, and a third light entrance member 33. The first light entrance member 31 is disposed on the object-side surface 211 of the first lens 21 and is fixed between the first lens 21 and the light blocking ring 111 of the lens barrel 11. The second light entrance member 32 is disposed between the image-side surface 212 of the first lens 21 and the object-side surface 221 of the second lens 22. The third light entrance member 33 is disposed between the image-side surface 232 of the third lens 23 and the object-side surface 241 of the fourth lens 24.

Specifically, the first light entrance member 31 surrounds the optical axis Z and correspondingly contacts the first optical ineffective area 21B of the first lens 21. The first light entrance member 31 has a first light entrance hole 311, wherein the first light entrance hole 311 communicates with the object-side opening 112 of the lens barrel 11 and faces the first optical effective area 21A of the first lens 21 to allow the optical axis Z to pass through. A diameter of the first light entrance hole 311 is smaller than or equal to the first maximum effective diameter of the first lens 21 and is smaller than or equal to a minimum inner diameter of the object-side opening 112 of the lens barrel 11. In the first embodiment as shown in FIG. 2, the diameter of the first light entrance hole 311, the first maximum effective diameter of the first lens 21, and the minimum inner diameter of the object-side opening 112 of the lens barrel 11 are all equal to one another.

The second light entrance member 32 surrounds the optical axis Z and correspondingly contacts the second optical ineffective area 22B of the second lens 22. The second light entrance member 32 has a second light entrance hole 321. The second light entrance hole 321 faces the second optical effective area 22A of the second lens 22 to allow the optical axis Z to pass through. A diameter of the second light entrance hole 321 is smaller than the second maximum effective diameter of the second lens 22. The third light entrance member 33 surrounds the optical axis Z and correspondingly contacts the third optical ineffective area 23B of the third lens 23 and the fourth optical ineffective area 24B of the fourth lens 24. The third light entrance member 33 has a third light entrance hole 331. The third light entrance hole 331 faces the fourth optical effective area 24A of the fourth lens 24 to allow the optical axis Z to pass through. A diameter of the third light entrance hole 331 is equal to the fourth maximum effective diameter of the fourth lens 24.

Furthermore, the optical image capturing lens 100 further includes an image sensing module 40. The image sensing module 40 is installed within the lens holder 12 of the first lens positioning unit 10 and is disposed correspondingly at a location on the image plane. The imaging light could pass through the imaging lens assembly 20 along the optical axis Z and project onto the image sensing module 40. When the image sensing module 40 detects the imaging light and converts the imaging light into an electrical signal, the image sensing module 40 sends the electrical signal to other external devices for further processing.

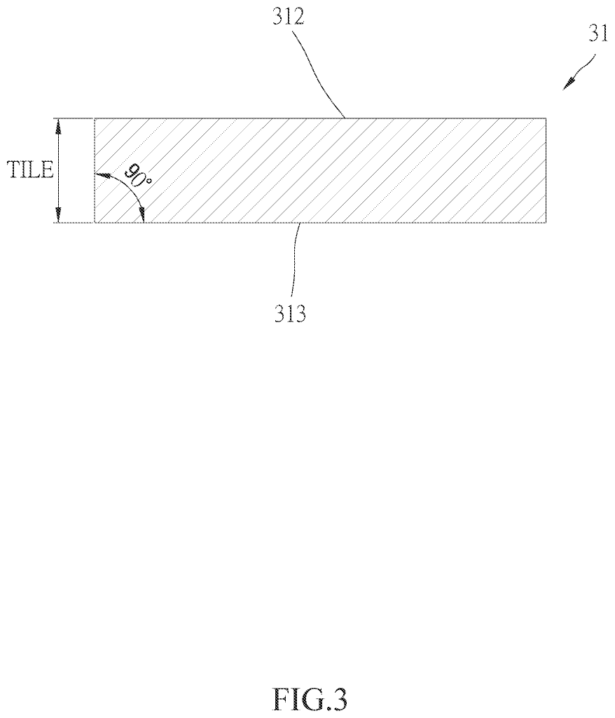

Furthermore, each light entrance member 30 satisfies: 0 μm<TILE≤50 μm, wherein TILE is a thickness of an inner peripheral edge of each light entrance member 30 at each light entrance hole. In an embodiment, each light entrance member 30 satisfies: 0.1 μm<TILE≤10 μm. Additionally, the configuration of an inner edge of the first light entrance hole 311 of the first light entrance member 31, the configuration of an inner edge of the second light entrance hole 321 of the second light entrance member 32, and the configuration of an inner edge of the third light entrance hole 331 of the third light entrance member 33 could be adjusted as needed. In this embodiment, the first light entrance member 31 is used for illustration. As shown in FIG. 3, the inner edge of the first light entrance hole 311 of the first light entrance member 31 is a rectangle. A top side and a bottom side of the first light entrance member 31 respectively have a top surface 312 and a bottom surface 313. TILE of the first light entrance member 31 is defined as a distance between the top surface 312 and the bottom surface 313.

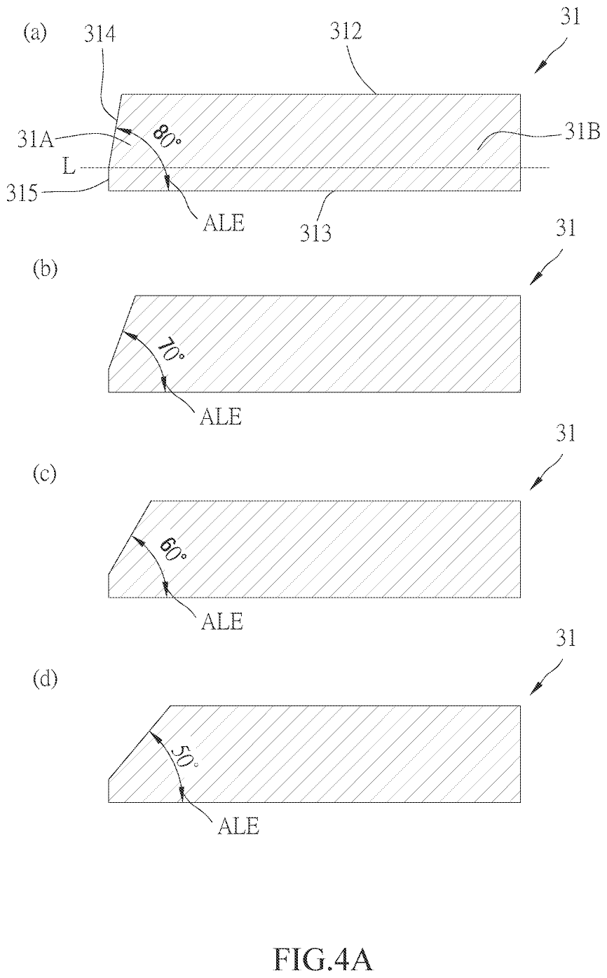

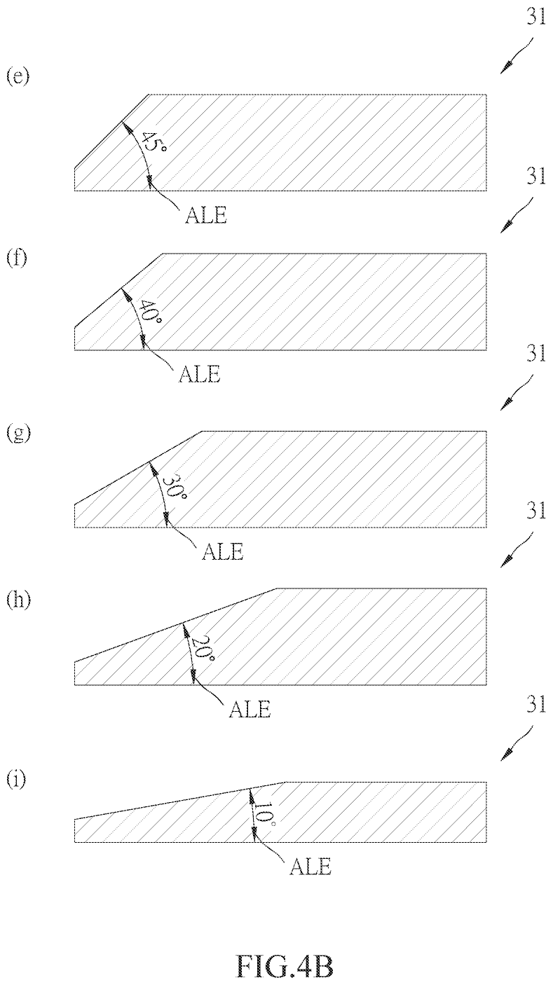

As shown in FIG. 4A and FIG. 4B, the configuration of the inner edge of the first light entrance hole 311 in the first embodiment could be adjusted to a trapezoidal configuration. The first light entrance member 31 has an inner annular section 31A and an outer annular section 31B, wherein the inner annular section 31A surrounds the first light entrance hole 311, and the outer annular section 31B surrounds an outer periphery of the inner annular section 31A. In this case, TILE of the first light entrance member 31 is defined as a minimum thickness of the inner annular section 31A. As shown in FIG. 4A and FIG. 4B, the inner annular section 31A of the first light entrance member 31 has an inner inclined portion 314 and a flat portion 315. The inner inclined portion 314 slopes downward from the top surface 312 of the outer annular section 31B towards the first light entrance hole 311, and the flat portion 315 extends along the optical axis Z and is connected to the inner inclined portion 314 and the bottom surface 313, so that the inner annular section 31A is in a trapezoidal shape. TILE of the first light entrance member 31 is defined as a thickness of the flat portion 315. The first light entrance member 31 defines a horizontal reference plane L. The horizontal reference plane L passes through the inner annular section 31A and the outer annular section 31B in correspondence to the first light entrance hole 311. The horizontal reference plane L is perpendicular to the optical axis Z and parallel to the bottom surface 313. The first light entrance member 31 satisfies: 10°≤ALE≤90°, wherein ALE is an inclination angle of the inner inclined portion 314 relative to the horizontal reference plane L. In FIG. 4A(a), ALE of the inner annular section 31A of the first light entrance member 31 is 80°. In FIG. 4A(b), ALE of the inner annular section 31A of the first light entrance member 31 is 70°. In FIG. 4A(c), ALE of the inner annular section 31A of the first light entrance member 31 is 60°. In FIG. 4A(d), ALE of the inner annular section 31A of the first light entrance member 31 is 50°. In FIG. 4B(e), ALE of the inner annular section 31A of the first light entrance member 31 is 40°. In FIG. 4B(f), ALE of the inner annular section 31A of the first light entrance member 31 is 30°. In FIG. 4B(g), ALE of the inner annular section 31A of the first light entrance member 31 is 20°. In FIG. 4B(h), ALE of the inner annular section 31A of the first light entrance member 31 is 10°.

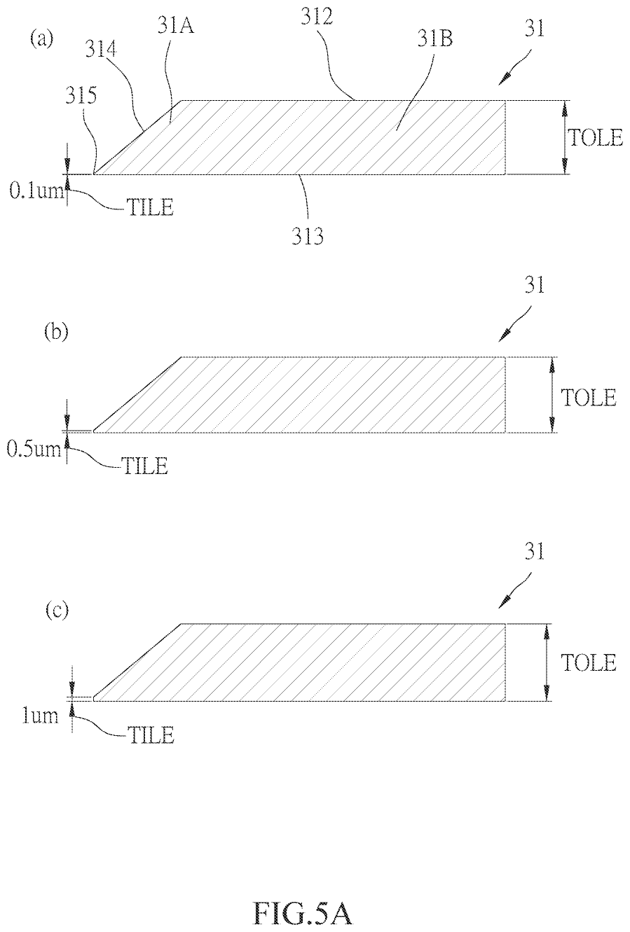

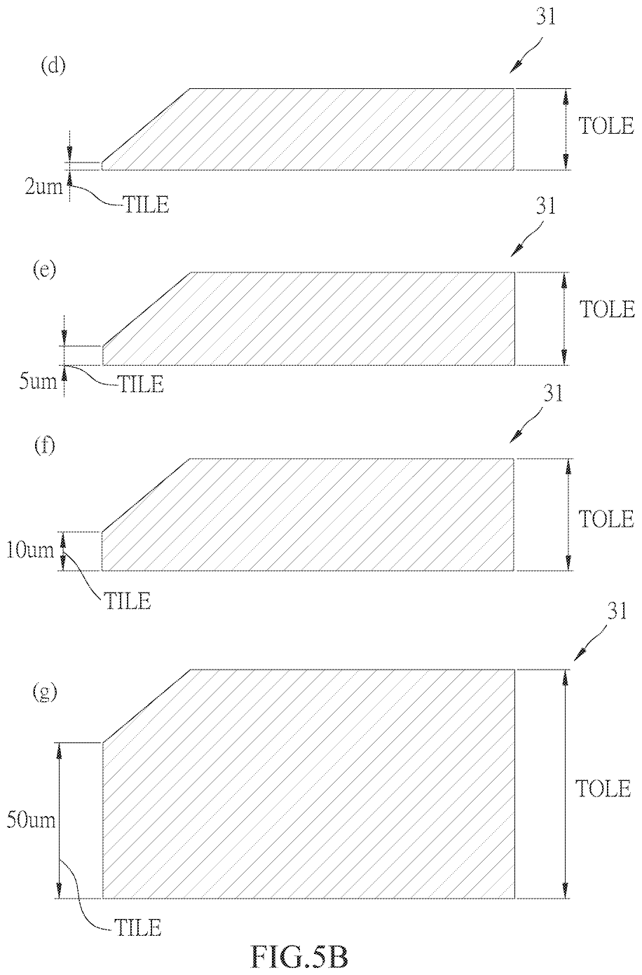

Furthermore, in the trapezoidal configuration of the first embodiment as shown in FIG. 5A and FIG. 5B, the thickness of the flat portion 315 of the first light entrance member 31 could be adjusted under the condition where the inner inclined portion 31A of the first light entrance member 31 maintains the same inclination angle relative to the horizontal reference plane L. As shown in FIG. 5A, the inner annular section 31A of the first light entrance member 31 has an angular configuration. In FIG. 5A(a), TILE of the inner annular section 31A of the first light entrance member 31 is 0.1 μm. In FIG. 5A(b), TILE of the inner annular section 31A of the first light entrance member is 0.5 μm. In FIG. 5A(c), TILE of the inner annular section 31A of the first light entrance member is 1.0 μm. As shown in FIG. 5B, the inner annular section 31A of the first light entrance member 31 is adjusted to the trapezoidal configuration. In FIG. 5B(d), TILE of the inner annular section 31A of the first light entrance member 31 is 2.0 μm. In FIG. 5B(e), TILE of the inner annular section 31A of the first light entrance member 31 is 5.0 μm. In FIG. 5B(f), TILE of the inner annular section 31A of the first light entrance member 31 is 10.0 μm. In FIG. 5B(g), TILE of the inner annular section 31A of the first light entrance member 31 is 50.0 μm. Thus, the first light entrance member 31 satisfies the following condition: 0 μm<TILE≤50 μm. Additionally, the first light entrance member 31 simultaneously satisfies: 0.008 mm≤TOLE≤0.2 mm, wherein TOLE is a maximum thickness of an outer peripheral edge of the first clear member 31 corresponding to the outer annular section 31B, namely a distance between the top surface 312 of the outer annular section 31B and the bottom surface 313.

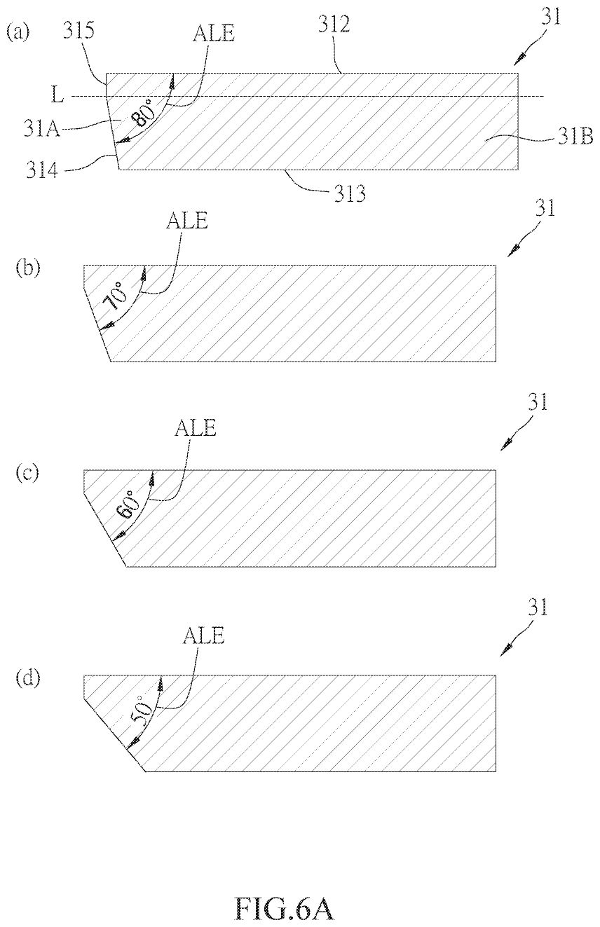

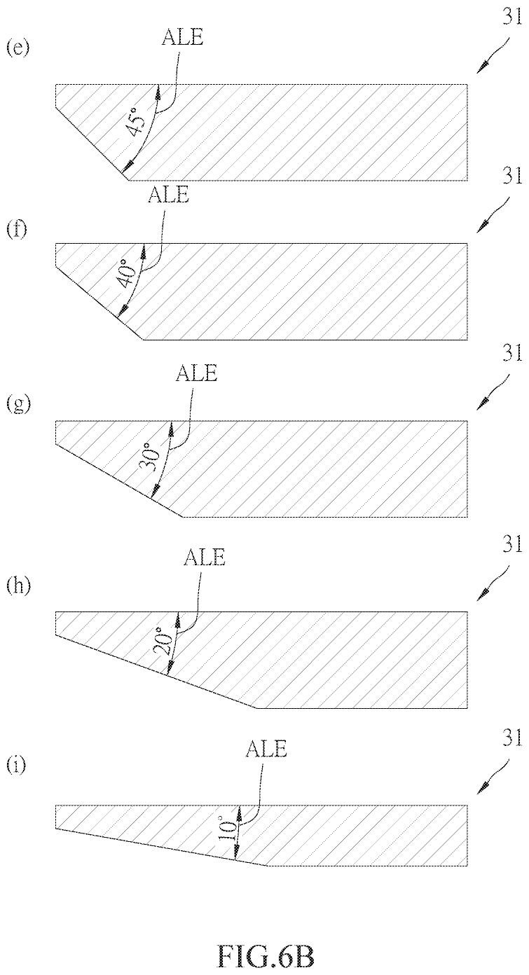

Furthermore, in the first embodiment as shown in FIG. 6A and FIG. 6B, the inner inclined portion 314 of the inner annular section 31A of the first light entrance member 31 could be adjusted to tilt upward from the bottom surface 313 of the outer annular section 31B towards the first light entrance hole 311, and the flat portion 315 could be adjusted to extend along the optical axis Z and to be connected to the inner inclined portion 314 and the top surface 312. The first light entrance member 31 satisfies: 10°≤ALE≤90°. In FIG. 6A(a), ALE of the inner annular section 31A of the first light entrance member 31 is 80°. In FIG. 6A(b), ALE of the inner annular section 31A of the first light entrance member 31 is 70°. In FIG. 6A(c), ALE of the inner annular section 31A of the first light entrance member 31 is 60°. In FIG. 6A(d), ALE of the inner annular section 31A of the first light entrance member 31 is 50°. In FIG. 6B(e), ALE of the inner annular section 31A of the first light entrance member 31 is 45°. In FIG. 6B(f), ALE of the inner annular section 31A of the first light entrance member 31 is 40°. In FIG. 6B(g), ALE of the inner annular section 31A of the first light entrance member 31 is 30°. In FIG. 6B(h), ALE of the inner annular section 31A of the first light entrance member 31 is 20°. In FIG. 6B(i), ALE of the inner annular section 31A of the first light entrance member 31 is 10°.

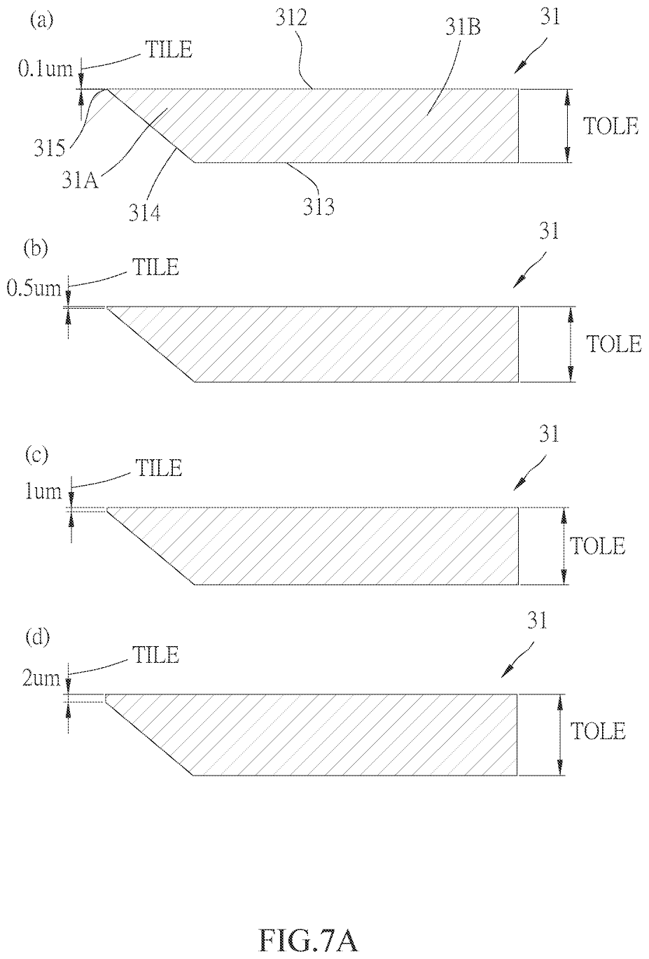

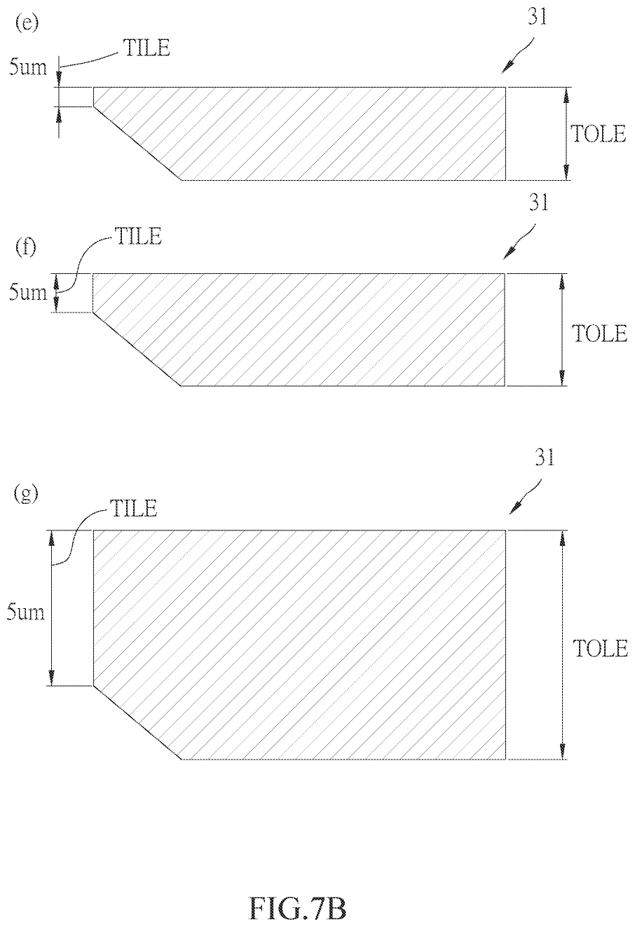

Furthermore, in the trapezoidal configuration of the first embodiment as shown in FIG. 7A and FIG. 7B, the thickness of the flat portion 315 of the first light entrance member 31 could also be adjusted under the condition where the inner inclined portion 31A of the first light entrance member 31 maintains the same inclination angle relative to the horizontal reference plane L. The first light entrance member 31 satisfies: 0 μm<TILE≤50 μm, and the first light entrance member 31 simultaneously satisfies: 0.008 mm≤TOLE≤0.2 mm, wherein TOLE is a maximum thickness of an outer peripheral edge of the first clear member 31 corresponding to the outer annular section 31B.

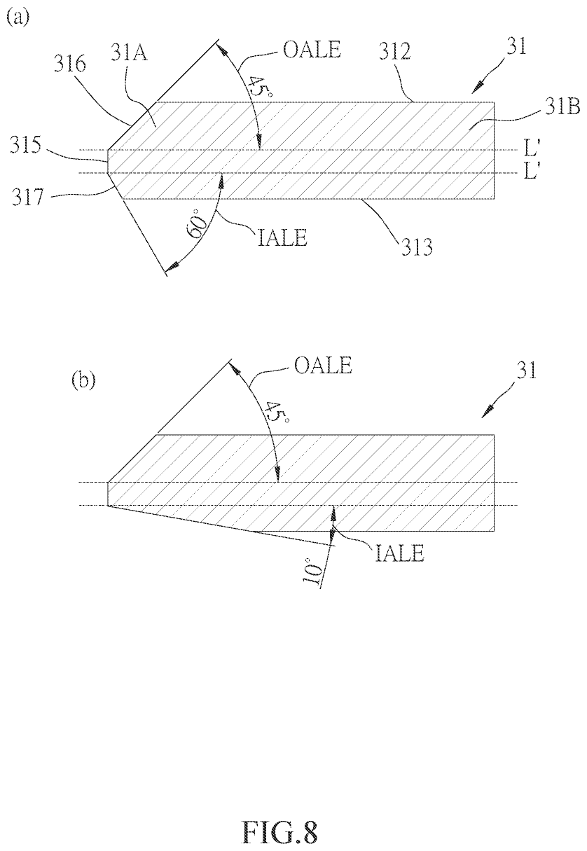

Furthermore, in the first embodiment as shown in FIG. 8, the inner edge of the first light entrance hole 311 could be adjusted to be in a tapered configuration. The inner annular section 31A of the first light entrance member 31 includes a first inner inclined portion 316 and a second inner inclined portion 317. The first inner inclined portion 316 and the second inner inclined portion 317 extend with opposite inclinations. The first inner inclined portion 316 slopes downward from the top surface 312 of the outer annular section 31B towards the first light entrance hole 311. The second inner inclined portion 317 slopes upward from the bottom surface 313 of the outer annular section 31B towards the first light entrance hole 311. The flat portion 315 extends along the optical axis Z and is connected to the first inner inclined portion 316 and the second inner inclined portion 317, so that the inner annular section 31A is in a tapered shape. TILE of the first light entrance member 31 is defined as the thickness of the flat portion 315. The first light entrance member 31 defines a horizontal reference plane L′. The horizontal reference plane L′ passes through the inner annular section 31A and the outer annular section 31B in correspondence to the first light entrance hole 311 and is perpendicular to the optical axis Z. The first light entrance member 31 satisfies: 10°≤OALE≤90°; 10°≤IALE≤90°, wherein OALE is an inclination angle of the first inner inclined portion 316 relative to the horizontal reference plane L′, and IALE is an inclination angle of the second inner inclined portion 317 relative to the horizontal reference plane L′. Additionally, the first light entrance member 31 satisfies: 0.1 μm<TILE≤10 μm; 0.008 mm≤TOLE≤0.2 mm.

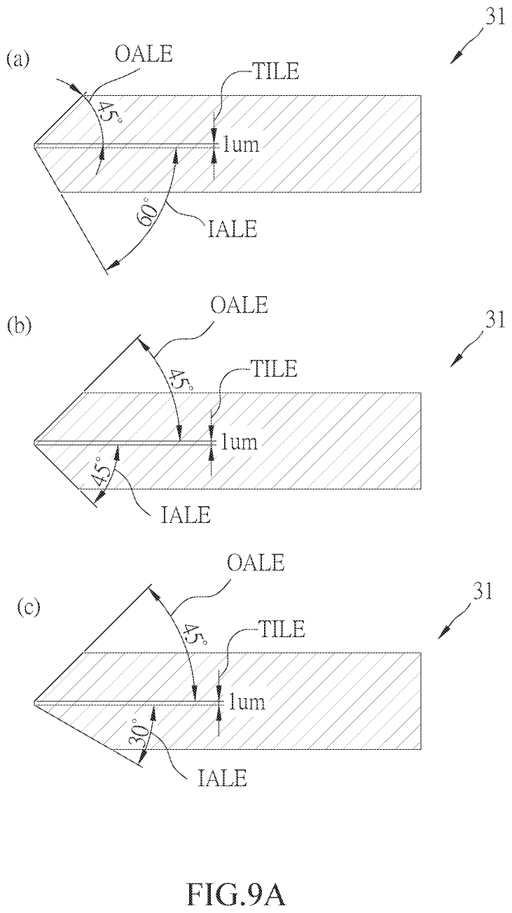

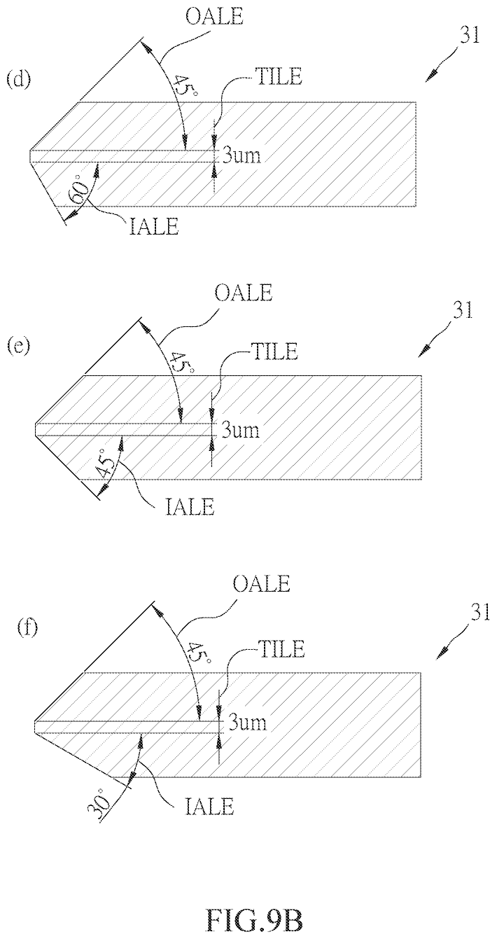

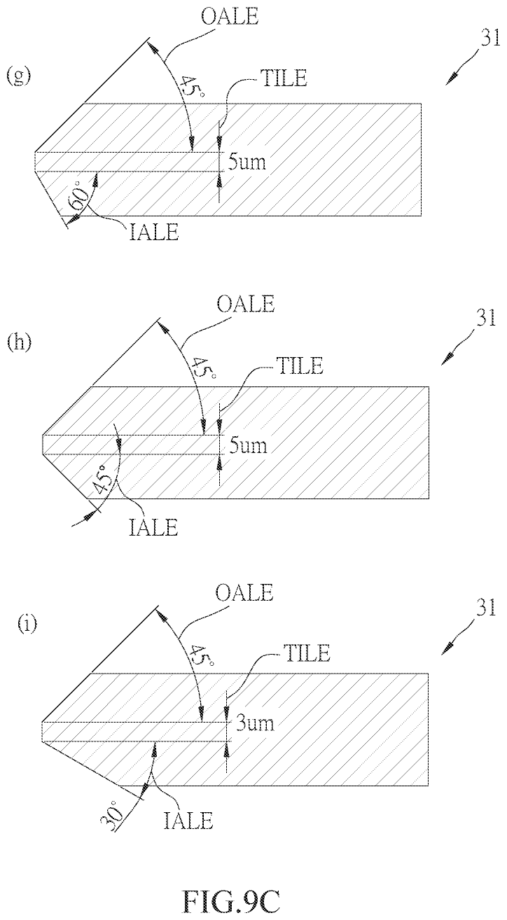

Specifically, as shown in FIG. 8(a), OALE of the inner annular section 31A of the first light entrance member 31 is 45°, and IALE of the inner annular section 31A of the first light entrance member 31 is 60°. In FIG. 8(b), OALE of the inner annular section 31A of the first light entrance member 31 is 45°, and IALE of the inner annular section 31A of the first light entrance member 31 is 10°. However, the OALE condition, the IALE condition, and the TILE condition of the inner annular section 31A of the first light entrance member 31 are not limited thereto. The OALE condition, the IALE condition, and the TILE condition of the inner annular section 31A of the first light entrance member 31 could be adjusted as needed. Examples are shown in FIG. 9A to FIG. 9C. In FIG. 9A(a) to FIG. 9A(c), TILE of each first light entrance member 31 is 1.0 μm. In FIG. 9A(a), OALE of the inner annular section 31A of the first light entrance member 31 is 45°, and IALE of the inner annular section 31A of the first light entrance member 31 is 60°. In FIG. 9A(b), OALE of the inner annular section 31A of the first light entrance member 31 is 45°, and IALE of the inner annular section 31A of the first light entrance member 31 is 45°. In FIG. 9A(c), OALE of the inner annular section 31A of the first light entrance member 31 is 45°, and OALE of 45°, and IALE of the inner annular section 31A of the first light entrance member 31 is 30°. In FIG. 9B(d) to FIG. 9B(f), TILE of each first light entrance member 31 is 3.0 μm. In FIG. 9B(d), OALE of the inner annular section 31A of the first light entrance member 31 is 45°, and IALE of the inner annular section 31A of the first light entrance member 31 is 60°. In FIG. 9B(e), OALE of the inner annular section 31A of the first light entrance member 31 is 45°, and IALE of the inner annular section 31A of the first light entrance member 31 is 45°. In FIG. 9B(f), OALE of the inner annular section 31A of the first light entrance member 31 is 45°, and IALE of the inner annular section 31A of the first light entrance member 31 is 30°. In FIG. 9C(g) to FIG. 9C(i), TILE of each first light entrance member 31 is 5.0 μm. In FIG. 9C(g), OALE of the inner annular section 31A of the first light entrance member 31 is 45°, and IALE of the inner annular section 31A of the first light entrance member 31 is 60°. In FIG. 9C(h), OALE of the inner annular section 31A of the first light entrance member 31 is 45°, and IALE of the inner annular section 31A of the first light entrance member 31 is 45°. In FIG. 9C(i), OALE of the inner annular section 31A of the first light entrance member 31 is 45°, and IALE of the inner annular section 31A of the first light entrance member 31 is 30°.

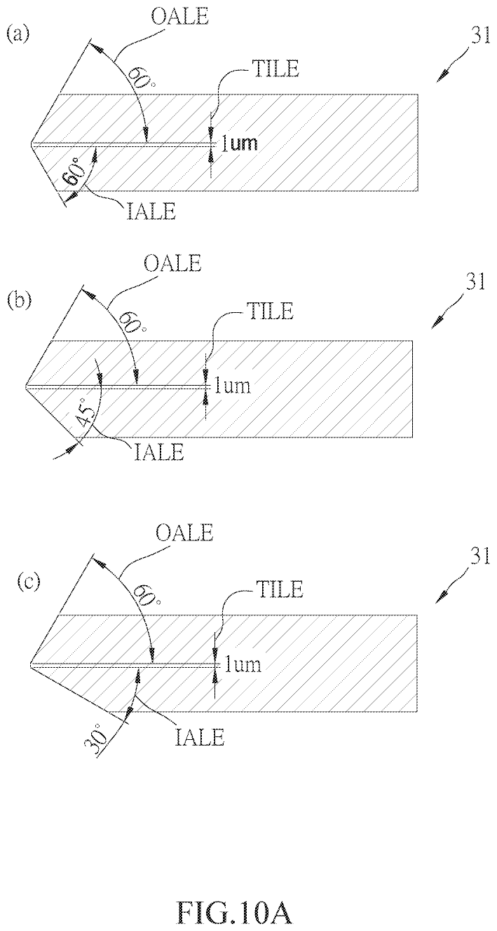

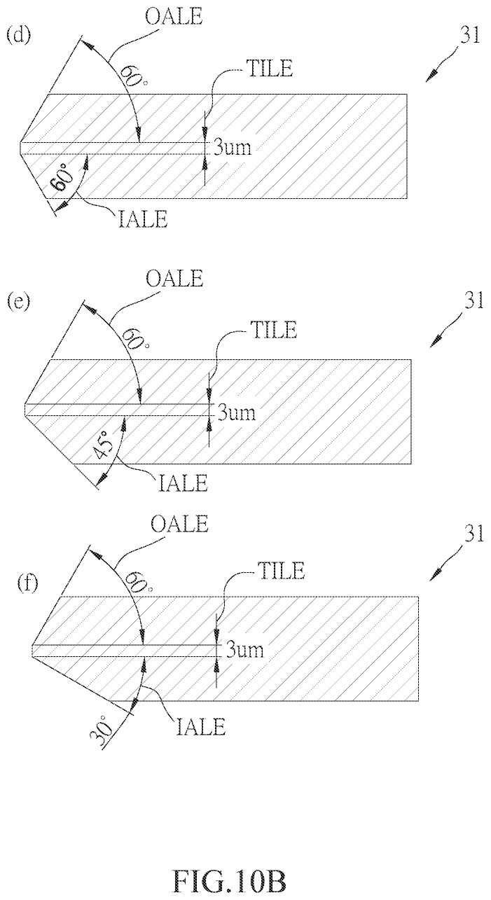

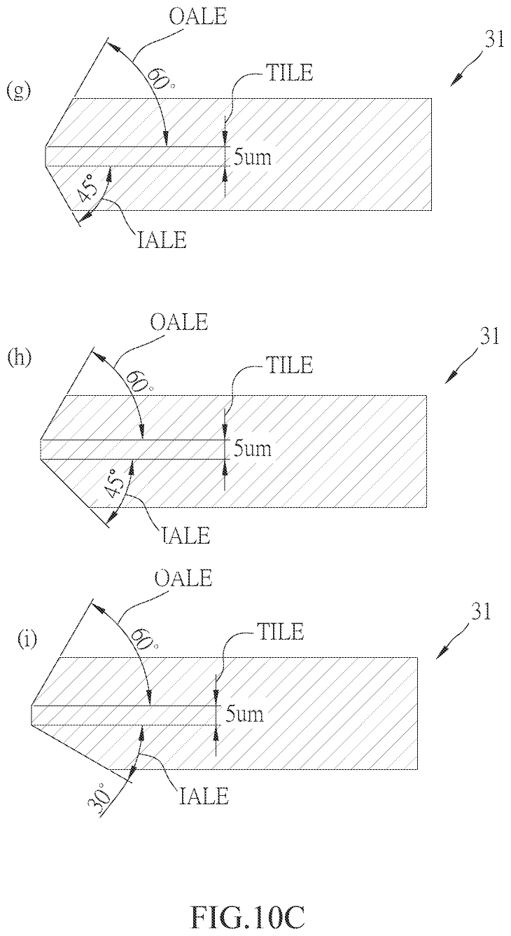

Additionally, please refer to FIG. 10A to FIG. 10C. In FIG. 10A(a) to FIG. 10A(c), TILE of the inner annular section 31A of the first light entrance member 31 is 1.0 μm. In FIG. 10A(a), OALE of the inner annular section 31A of the first light entrance member 31 is 60°, and IALE of the inner annular section 31A of the first light entrance member 31 is 60°. In FIG. 10A(b), OALE of the inner annular section 31A of the first light entrance member 31 is 60°, and IALE of the inner annular section 31A of the first light entrance member 31 is 45°. In FIG. 10A(c), OALE of the inner annular section 31A of the first light entrance member 31 is 60°, and IALE of the inner annular section 31A of the first light entrance member 31 is 30°. In FIG. 10B(d) to FIG. 10B(f), TILE of each inner annular section 31A of the first light entrance member 31 is 3.0 μm. In FIG. 10B(d), OALE of the inner annular section 31A of the first light entrance member 31 is 60°, and IALE of the inner annular section 31A of the first light entrance member 31 is 60°. In FIG. 10B(e), OALE of the inner annular section 31A of the first light entrance member 31 is 60°, and IALE of the inner annular section 31A of the first light entrance member 31 is 45°. In FIG. 10B(f), OALE of the inner annular section 31A of the first light entrance member 31 is 60°, and IALE of the inner annular section 31A of the first light entrance member 31 is 30°. In FIG. 10C(g) to FIG. 10C(i), TILE of each inner annular section 31A of the first light entrance member 31 is 5.0 μm. In FIG. 10C(g), OALE of the inner annular section 31A of the first light entrance member 31 is 60°, and IALE of the inner annular section 31A of the first light entrance member 31 is 60°. In FIG. 10C(h), OALE of the inner annular section 31A of the first light entrance member 31 is 60°, and IALE of the inner annular section 31A of the first light entrance member 31 is 45°. In FIG. 10C(i), OALE of the inner annular section 31A of the first light entrance member 31 is 60°, and IALE of the inner annular section 31A of the first light entrance member 31 is 30°.

In summary, the various configurations and conditions of the first light entrance member 31 in the first embodiment are based on the condition that the diameter of the first light entrance hole 311 is smaller than or equal to the first maximum effective diameter of the first lens 21, thereby blocking a non-imaging light from passing through the first lens 21. Similarly, the configurations and dimensions of the second light entrance member 32 and the third light entrance member 33 could also be adjusted as needed. Thus, the optical image capturing lens 100 could effectively block the non-imaging light from entering the imaging lens assembly 20 through the design of the light entrance members 30. The design of the light entrance members 30 not only reduces the interference from the non-imaging light and hence enhances imaging quality, but also reduces the dimensions of each light entrance member 30 to achieve the effects of miniaturizing the optical image capturing lens 100 and improving image quality through the TILE and TOLE conditions of the light entrance members 30.

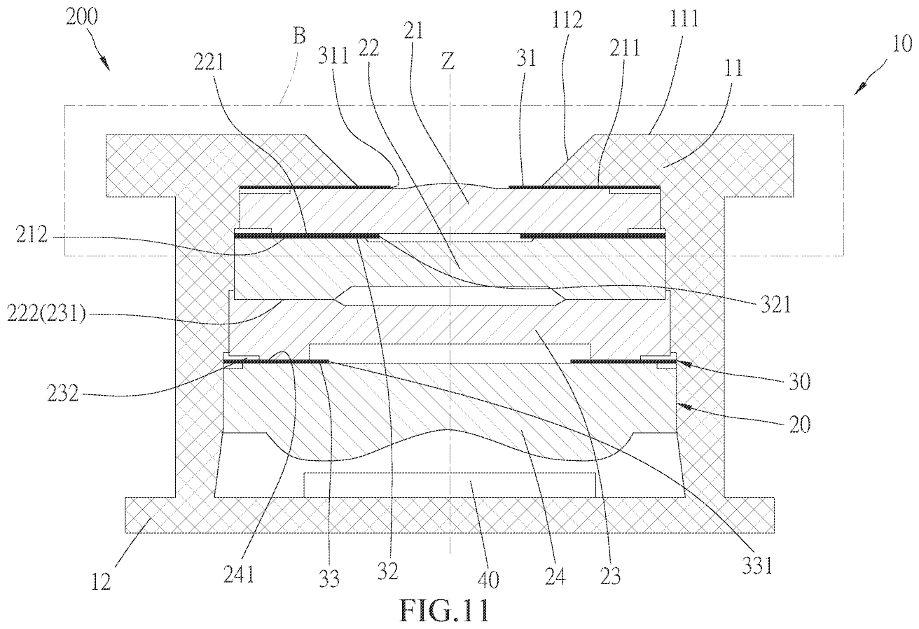

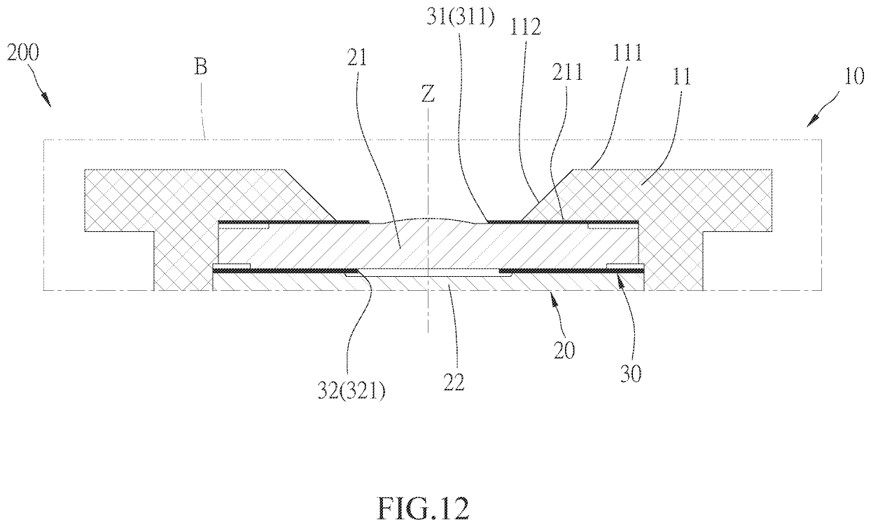

An optical image capturing lens 200 according to a second embodiment of the present invention is illustrated in FIG. 11 and FIG. 12 and includes the aforementioned first lens positioning unit 10, the imaging lens assembly 20, the plurality of light entrance members 30, and the image sensing module 40. In the second embodiment, the structure and positioning of the first lens positioning unit 10, the imaging lens assembly 20, the light entrance members 30, and the image sensing module 40 are identical to those in the first embodiment mentioned above.

In the second embodiment, the imaging lens assembly 20, along the optical axis Z from the object side to the image side starting from the object-side opening 112, includes the first lens 21, the second lens 22, the third lens 23, and the fourth lens 24. The plurality of light entrance members 30 include of the first light entrance member 31, the second light entrance member 32, and the third light entrance member 33. The first light entrance member 31 is disposed on the object-side surface 211 of the first lens 21 and is fixed between the first lens 21 and the light blocking ring 111 of the lens barrel 11. The second light entrance member 32 is disposed between the image-side surface 212 of the first lens 21 and the object-side surface 221 of the second lens 22. The third light entrance member 33 is disposed between the image-side surface 232 of the third lens 23 and the object-side surface 241 of the fourth lens 24.

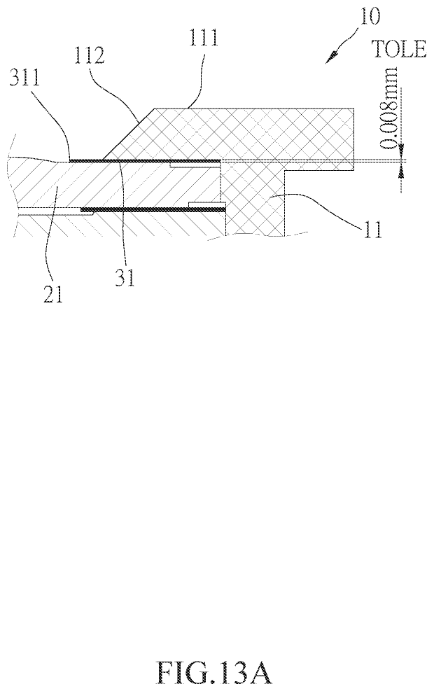

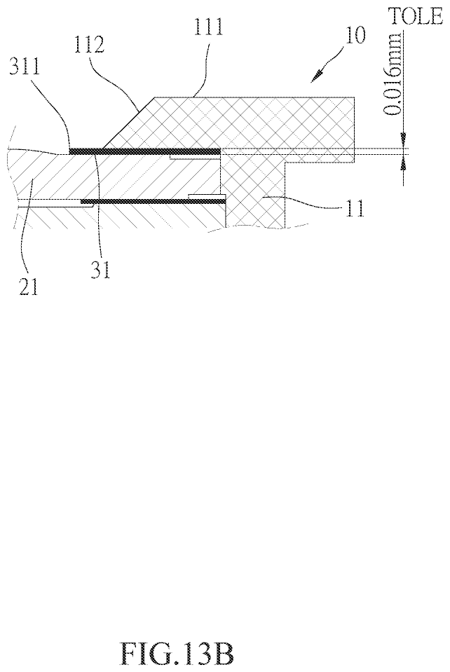

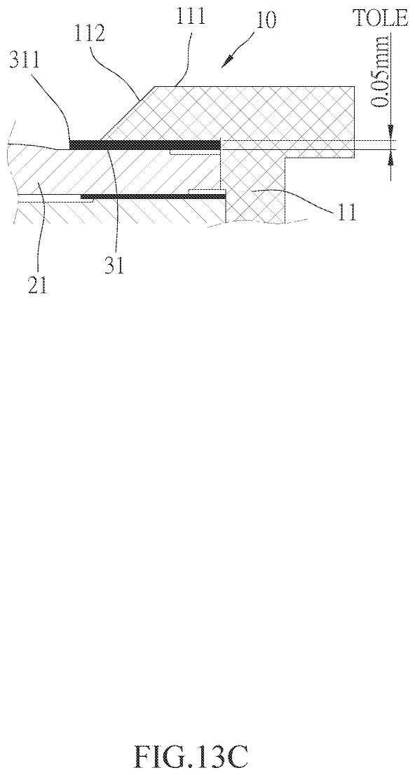

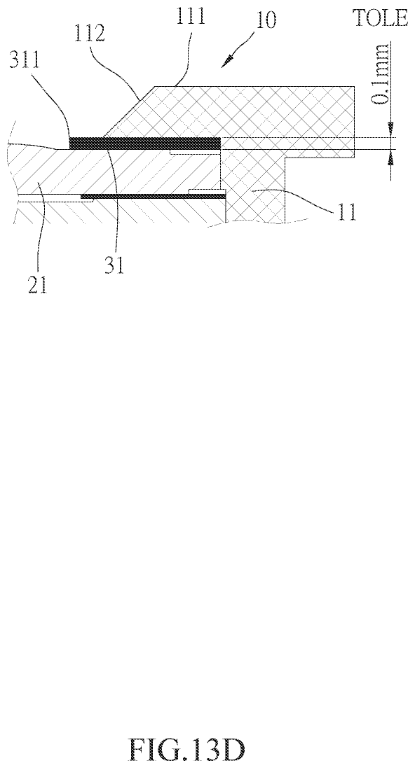

Specifically, in the second embodiment as shown in FIG. 12, an inner diameter of the object-side opening 112 of the lens barrel 11 is enlarged, so that the diameter of the first light entrance hole 311 of the first light entrance member 31 is smaller than the minimum inner diameter of the object-side opening 112. Additionally, the diameter of the first light entrance hole 311 is equal to the first maximum effective diameter of the first lens 21. TOLE of the first light entrance member 31 could be adjusted as needed. Examples are shown in FIG. 13A to FIG. 13D. In FIG. 13A, TOLE of the first light entrance member 31 is 0.008 mm. In FIG. 13B, TOLE of the first light entrance member 31 is 0.016 mm. In FIG. 13C, TOLE of the first light entrance member 31 is 0.05 mm. In FIG. 13D, TOLE of the first light entrance member 31 is 0.1 mm. Thus, the first light entrance member 31 satisfies: 0.008 mm≤TOLE≤0.2 mm.

Furthermore, the light entrance members 30 satisfy: 0 μm≤CONP≤50 μm, 0 μm≤CONE≤50 μm, and 0 μm≤CON≤50 μm, wherein each light entrance hole has a light entrance central axis CLE; CONP is a distance between the light entrance central axis CLE at each light entrance hole and the optical axis Z in a direction perpendicular to the optical axis Z; the object-side opening 112 has an opening central axis CPE; CONE is a distance between the opening central axis CPE at the object-side opening 112 and the optical axis Z in the direction perpendicular to the optical axis Z; CON is a maximum distance between the light entrance central axis CLE at the light entrance hole and the opening central axis CPE light entrance hole at the object-side opening 112 in the direction perpendicular to the optical axis Z.

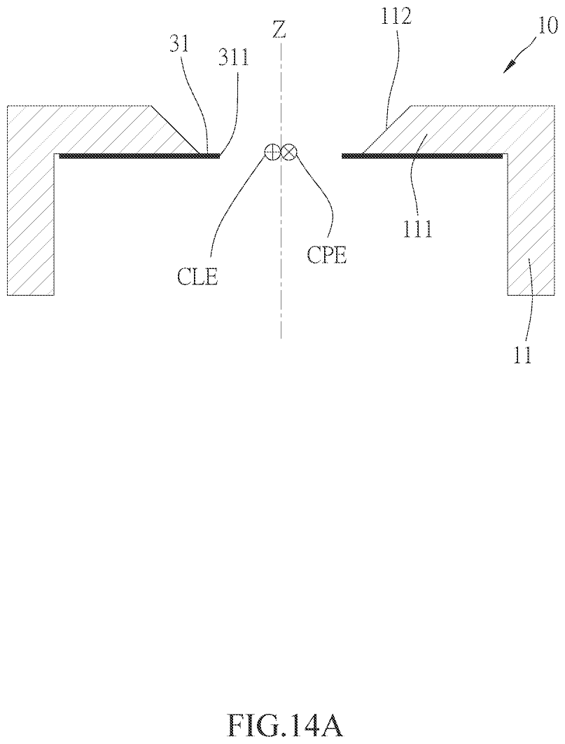

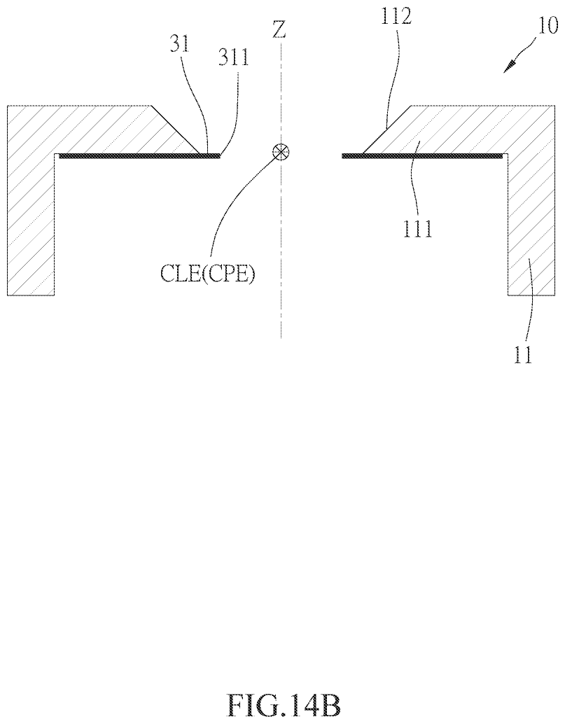

Examples are shown in FIG. 14A and FIG. 14B. In FIG. 14A, the light entrance central axis CLE of the first light entrance hole 311 of the first light entrance member 31 is disposed on one side of the optical axis Z, and the opening central axis CPE of the object-side opening 112 of the lens barrel 11 is located on another side of the optical axis Z. CONP denotes an offset between the light entrance central axis CLE of the first light entrance hole 311 and the optical axis Z. CONE denotes an offset between the opening central axis CPE of the object-side opening 112 and the optical axis Z. CON denotes an offset between the opening central axis CPE of the object-side opening 112 and the light entrance central axis CLE of the first light entrance hole 311. In FIG. 14B, the light entrance central axis CLE of the first light entrance hole 311 of the clear member 31, the opening central axis CPE of the object-side opening 112 of the lens barrel 11, and the optical axis Z overlap, denoting the first light entrance hole 311 of the first light entrance member 31 and the object-side opening 112 of the lens barrel 11 are concentrically designed.

Thus, the design of the first light entrance member 31 in the second embodiment is similarly based on the condition that the diameter of the first light entrance hole 311 is smaller than or equal to the first maximum effective diameter of the first lens 21, thereby blocking the non-imaging light from passing through the first lens 21.

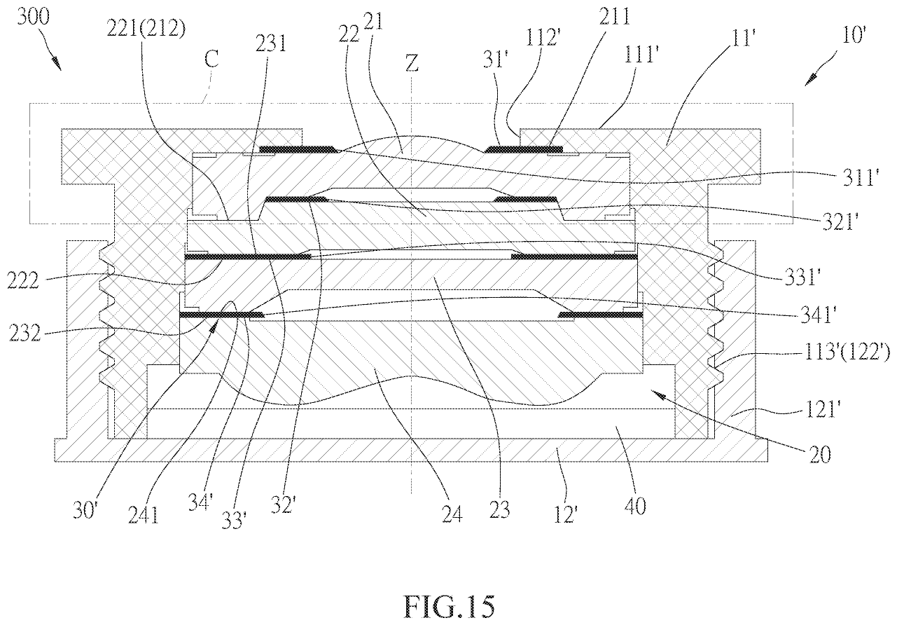

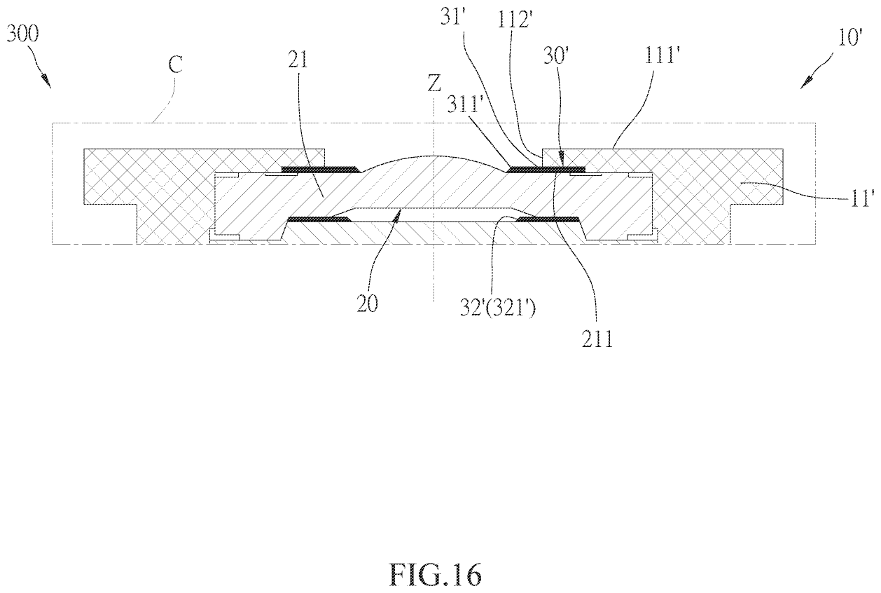

An optical image capturing lens 300 according to a third embodiment of the present invention is illustrated in FIG. 15 and FIG. 16 and includes a first lens positioning unit 10′, the aforementioned imaging lens assembly 20, a plurality of light entrance members 30′, and the image sensing module 40. The imaging lens assembly 20 and the image sensing module 40 in the third embodiment are identical to those in the first embodiment.

An interior of the first lens positioning unit 10′ is hollow, and the first lens positioning unit 10 is made of an opaque material. In this embodiment, the first lens positioning unit 10′ includes a lens barrel 11′ and a lens holder 12′. One end of the lens barrel 11′ contracts radially inward to form a light blocking ring 111′, wherein an inner edge of the light blocking ring 111′ surrounds to form an object-side opening 112′. The object-side opening 112′ communicates with an interior of the lens barrel 11′. An external thread 113′ is disposed on another end of the lens barrel 11′. The lens holder 12′ extends upward to form a connecting portion 121′. The connecting portion 121′ has an internal thread 122′ correspondingly engaged with the external threads 113′ of the lens barrel 11′, allowing the lens barrel 11′ and the lens holder 12′ to be detachably screwed together.

The imaging lens assembly 20, along an optical axis Z from an object side to an image side starting from the object-side opening 112, includes the first lens 21, the second lens 22, the third lens 23, and the fourth lens 24. The structure of the first lens 21, the second lens 22, the third lens 23, and the fourth lens 24 in the third embodiment are identical to those in the first embodiment.

The light entrance members 30′ include a first light entrance member 31′, a second light entrance member 32′, a third light entrance member 33′, and a fourth light entrance member 34′. The first light entrance member 31′ is disposed on the object-side surface 211 of the first lens 21 and is fixed between the first lens 21 and the light blocking ring 111′ of the lens barrel 11′. As shown in FIG. 16, the first light entrance member 31′ has a first light entrance hole 311′, wherein the first light entrance hole 311′ communicates with the object-side opening 112′ of the lens barrel 11′ to allow the optical axis Z to pass through. A diameter of the first light entrance hole 311′ is equal to the first maximum effective diameter of the first lens 21 and is smaller than a minimum inner diameter of the object-side opening 112′ of the lens barrel 11′. As shown in FIG. 15, the second light entrance member 32′ is disposed between the image-side surface 212 of the first lens 21 and the object-side surface 221 of the second lens 22. The second light entrance member 32′ has a second light entrance hole 321′ to allow the optical axis Z to pass through. A diameter of the second light entrance hole 321′ is smaller than the second maximum effective diameter of the second lens 22. The third light entrance member 33′ is disposed between the image-side surface 222 of the second lens 22 and the object-side surface 231 of the third lens 23. The third light entrance member 33′ has a third light entrance hole 331′ to allow the optical axis Z to pass through. A diameter of the third light entrance hole 331′ is equal to the third maximum effective diameter of the third lens 23. The fourth light entrance member 34′ is disposed between the image-side surface 232 of the third lens 23 and the object-side surface 241 of the fourth lens 24. The fourth light entrance member 34′ has a fourth light entrance hole 341′ to allow the optical axis Z to pass through. A diameter of the fourth light entrance hole 341′ is smaller than the fourth maximum effective diameter of the fourth lens 24.

Thus, the design of the light entrance members 30′ in the third embodiment is similarly based on the condition that the diameter of each light entrance hole is smaller than or equal to the maximum effective diameter of each lens, so that the non-imaging light is blocked from passing through each lens.

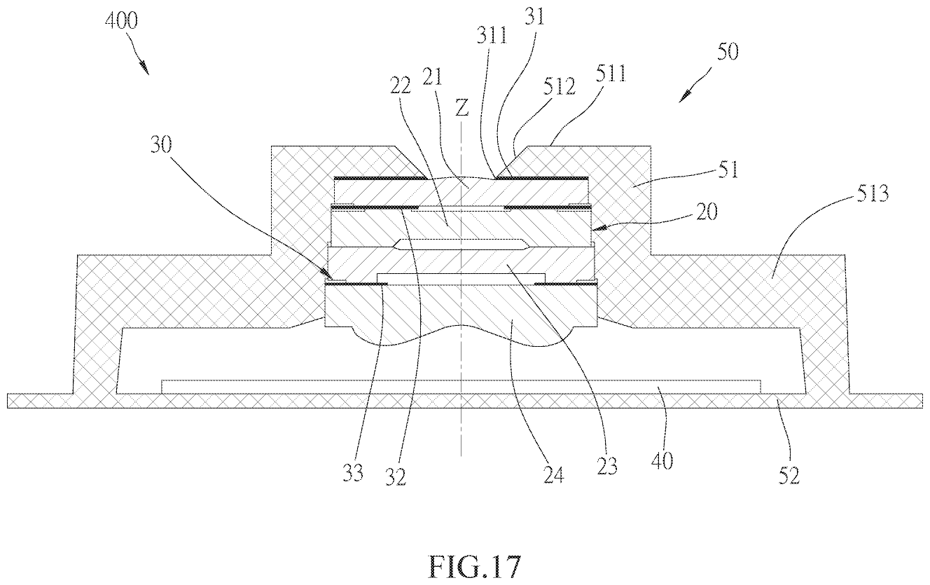

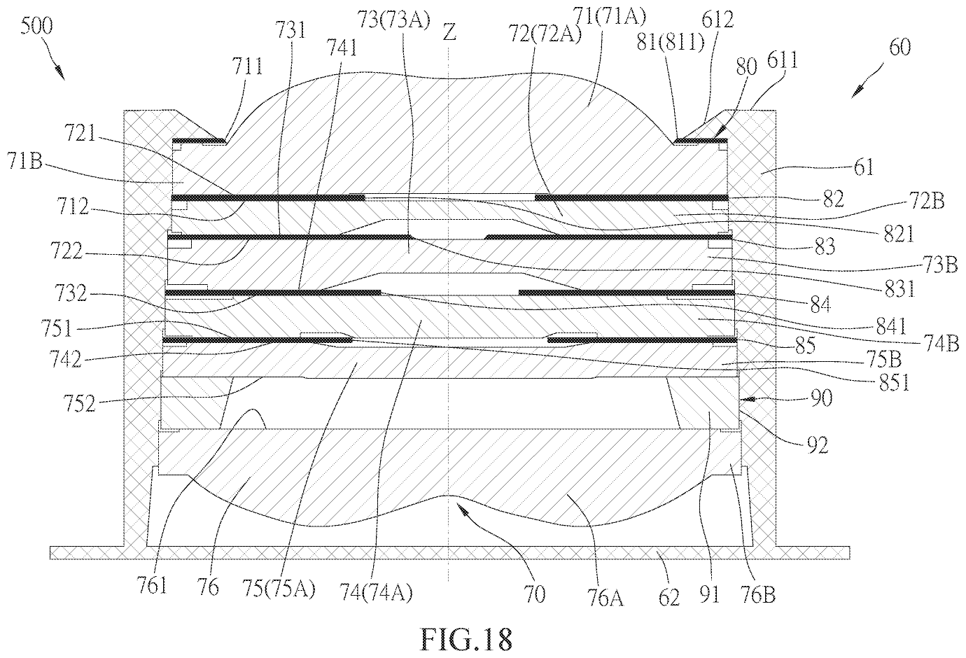

An optical image capturing lens 400 according to a fourth embodiment of the present invention is illustrated in FIG. 17 and FIG. 18 and includes a first lens positioning unit 50, the aforementioned imaging lens assembly 20, the plurality of light entrance members 30, and the image sensing module 40. The structure of the imaging lens assembly 20, the light entrance members 30, and the image sensing module 40 in the fourth embodiment is identical to that of the first embodiment, and would not be further elaborated here.

In the fourth embodiment, an interior of the first lens positioning unit 50 is hollow, and the first lens positioning unit 50 is made of an opaque material. In this embodiment, the first lens positioning unit 50 includes a lens barrel 51 and a lens holder 52 that are formed as an integrated structure. One end of the lens barrel 51 contracts radially inward to form a light blocking ring 511, wherein an inner edge of the light blocking ring 511 surrounds to form an object-side opening 512. The object-side opening 512 communicates with an interior of the lens barrel 51. Another end of the lens barrel 51 extends radially outward to form a shoulder portion 513. The lens holder 52 is combined with the shoulder portion 513 of the lens barrel 51. Thus, the design of the shoulder portion 513 of the lens barrel 51 allows the first lens positioning unit 50 to increase an internal space of the lens holder 52.

An optical image capturing lens 500 according to a fifth embodiment of the present invention is illustrated in FIG. 18 and includes a first lens positioning unit 60, an imaging lens assembly 70, a plurality of light entrance members 80, and a second lens positioning unit 90.

An interior of the first lens positioning unit 60 is hollow, and the first lens positioning unit 60 is made of an opaque material. In this embodiment, the first lens positioning unit 60 includes a lens barrel 61 and a lens holder 62 that are formed as an integrated structure. One end of the lens barrel 61 contracts radially inward to form a light blocking ring 611, wherein an inner edge of the light blocking ring 611 surrounds to form an object-side opening 612. The object-side opening 612 communicates with an interior of the lens barrel 61. The lens holder 62 is combined with another end of the lens barrel 61 opposite to the object-side opening 612

The imaging lens assembly 70 is installed within the lens barrel 61 of the first lens positioning unit 60. The imaging lens assembly 70, along an optical axis Z from an object side to an image side starting from the object-side opening 612, includes a first lens 71, a second lens 72, a third lens 73, a fourth lens 74, a fifth lens 75, a sixth lens 76, and an image plane. The first lens 71, second lens 72, third lens 73, fourth lens 74, and fifth lens 75 each have refractive power and are arranged sequentially within the interior of the lens barrel 61. The first lens 71 is located on an inner side of the light blocking ring 611, wherein an object-side surface 711, which faces the object side, of the first lens 71 is exposed to the object-side opening 612 of the lens barrel 61. The first lens 71 has a first optical effective area 71A and a first optical ineffective area 71B. The first optical effective area 71A is correspondingly exposed to the object-side opening 612 of the lens barrel 61, and the optical axis Z passes through the first optical effective area 71A. The first optical effective area 71A is surrounded by the first optical ineffective area 71B. The light blocking ring 611 correspondingly blocks the first optical ineffective area 71B of the first lens 71.

Furthermore, the first lens 71 defines a first maximum effective diameter at the first optical effective area 71A. A definition way of the first maximum effective diameter is the same as the definition way in the first embodiment. The optical axis Z passes through the first optical effective area 71A of the first lens 71, and the optical axis Z intersects with the object-side surface 711 of the first lens 71 to form an intersection point. A distance from the intersection point to a maximum effective half diameter position in a direction perpendicular to the optical axis Z is defined as a maximum effective half diameter. The first maximum effective diameter is defined as twice the distance of the maximum effective half diameter and is perpendicular to the optical axis Z. The maximum effective half diameter position of the first lens 71 is defined as a very edge of the first optical effective area 71A being in contact with the first optical ineffective area 71B.

An object-side surface 721 of the second lens 72 faces an image-side surface 712 of the first lens 71. The second lens 72 has a second optical effective area 72A and a second optical ineffective area 72B. The second optical ineffective area 72A faces the first optical effective area 72A, and the optical axis Z passes through the second optical effective area 72A. The second optical effective area 72A is surrounded by the second optical ineffective area 72B, and the second optical ineffective area 72B correspondingly faces the first optical ineffective area 71B. The second lens 72 defines a second maximum effective diameter at the second optical effective area 72A. In this embodiment, a definition way of the second maximum effective diameter is the same as the definition way of the first maximum effective diameter.

An object-side surface 731 of the third lens 73 faces an image-side surface 722 of the second lens 72. The third lens 73 has a third optical effective area 73A and a third optical ineffective area 73B. The third optical effective area 73A faces the second optical effective area 72A, and the optical axis Z passes through the third optical effective area 73A. The third optical effective area 73A is surrounded by the third optical ineffective area 73B, and the third optical ineffective area 73B correspondingly faces the second optical ineffective area 72B. The third lens 73 defines a third maximum effective diameter at the third optical effective area 73A. In this embodiment, a definition way of the third maximum effective diameter is the same as the definition way of the first maximum effective diameter.

An object-side surface 741 of the fourth lens 74 faces an image-side surface 732 of the third lens 73. The fourth lens 74 has a fourth optical effective area 74A and a fourth optical ineffective area 74B. The fourth optical effective area 74A faces the third optical effective area 73A, and the optical axis Z passes through the fourth optical effective area 74A. The fourth optical effective area 74A is surrounded by the fourth optical ineffective area 74B, and the fourth optical ineffective area 74B correspondingly faces the third optical ineffective area 73B. The fourth lens 74 defines a fourth maximum effective diameter at the fourth optical effective area 74A. In this embodiment, a definition way of the fourth maximum effective diameter is the same as the definition way of the first maximum effective diameter.

An object-side surface 751 of the fifth lens 75 faces an image-side surface 742 of the fourth lens 74. The fifth lens 75 has a fifth optical effective area 75A and a fifth optical ineffective area 75B. The fifth optical effective area 75A faces the fourth optical effective area 74A, and the optical axis Z passes through the fifth optical effective area 75A. The fifth optical effective area 75A is surrounded by the fifth optical ineffective area 75B, and the fifth optical ineffective area 75B correspondingly faces the fourth optical ineffective area 74B. The fifth lens 75 defines a fifth maximum effective diameter at the fifth optical effective area 75A. In this embodiment, a definition way of the fifth maximum effective diameter is the same as the definition way of the first maximum effective diameter.

An object-side surface 761 of the sixth lens 76 faces the image-side surface 752 of the fifth lens 75. The sixth lens 76 has a sixth optical effective area 76A and a sixth optical ineffective area 76B. The sixth optical effective area 76A faces the fifth optical effective area 75A, and the optical axis Z passes through the sixth optical effective area 76A. The sixth optical effective area 76A is surrounded by the sixth optical ineffective area 76B, and the sixth optical ineffective area 76B correspondingly faces the fifth optical ineffective area 75B. The sixth lens 76 defines a sixth maximum effective diameter at the sixth optical effective area 76A. In this embodiment, a definition way of the sixth maximum effective diameter is the same as the definition way of the first maximum effective diameter.

Each of the light entrance members 80 is made of an opaque material and is installed within the lens barrel 61 of the first lens positioning unit 60. In the fifth embodiment as shown in FIG. 18, the light entrance members 80 include a first light entrance member 81, a second light entrance member 82, a third light entrance member 83, a fourth light entrance member 84, and a fifth light entrance member 85. The first light entrance member 81 is disposed on the object-side surface 711 of the first lens 71 and is fixed between the first lens 71 and the light blocking ring 611. In this embodiment, the first light entrance member 81 surrounds the optical axis Z and correspondingly contacts the first optical ineffective area 71B of the first lens 71. The first light entrance member 81 has a first light entrance hole 811, wherein the first light entrance hole 811 communicates with the object-side opening 612 of the lens barrel 61 to allow the optical axis Z to pass through. A diameter of the first light entrance hole 811 is smaller than or equal to the first maximum effective diameter of the first lens 71 and is smaller than a minimum inner diameter of the object-side opening 612 of the lens barrel 61.

As shown in FIG. 18, the second light entrance member 82 is disposed between the image-side surface 712 of the first lens 71 and the object-side surface 721 of the second lens 72. In this embodiment, the second light entrance member 82 surrounds the optical axis Z and correspondingly contacts the first optical ineffective area 71B of the first lens 71 and the second optical ineffective area 72B of the second lens 72. The second light entrance member 82 has a second light entrance hole 821, wherein the optical axis Z passes through the second light entrance hole 821. A diameter of the second light entrance hole 821 is smaller than the second maximum effective diameter of the second lens 72. The third light entrance member 83 is disposed between the image-side surface 722 of the second lens 72 and the object-side surface 731 of the third lens 73. In this embodiment, the third light entrance member 83 surrounds the optical axis Z and correspondingly contacts the second optical ineffective area 72B of the second lens 72 and the third optical ineffective area 73B of the third lens 73. The third light entrance member 83 has a third light entrance hole 831 to allow the optical axis Z to pass through. A diameter of the third light entrance hole 831 is equal to the third maximum effective diameter of the third lens 73. The fourth light entrance member 84 is disposed between the image-side surface 732 of the third lens 73 and the object-side surface 741 of the fourth lens 74. In this embodiment, the fourth light entrance member 84 surrounds the optical axis Z and correspondingly contacts the third optical ineffective area 73B of the third lens 73 and the fourth optical ineffective area 74B of the fourth lens 74. The fourth light entrance member 84 has a fourth light entrance hole 841 to allow the optical axis Z to pass through. A diameter of the fourth light entrance hole 841 is smaller than the fourth maximum effective diameter of the fourth lens 74. The fifth light entrance member 85 is disposed between the image-side surface 742 of the fourth lens 74 and the object-side surface 751 of the fifth lens 75. In this embodiment, the fifth light entrance member 85 surrounds the optical axis Z and correspondingly contacts the fourth optical ineffective area 74B of the fourth lens 74 and the fifth optical ineffective area 75B of the fifth lens 75. The fifth light entrance member 85 has a fifth light entrance hole 851 to allow the optical axis Z to pass through. A diameter of the fifth light entrance hole 851 is smaller than the fifth maximum effective diameter of the fifth lens 75.

Furthermore, the light entrance members 80 satisfy: 0 μm<TILE≤50 μm, 0 μm≤CONP≤50 μm, 0 μm≤CONE≤50 μm, and 0 μm≤CON≤50 μm. The configurations and dimensions of the light entrance members 80 could be adjusted as needed.

The second lens positioning unit 90 is made of an opaque material and is installed within the lens barrel 61 of the first lens positioning unit 60 and is adapted to position each lens of the imaging lens assembly 70. In this embodiment as shown in FIG. 18, the second lens positioning unit 90 is installed between the image-side surface 752 of the fifth lens 75 and the object-side surface 761 of the sixth lens 76. The second lens positioning unit 90 has an annular portion 91 and an abutting portion 92. The annular portion 91 contacts the fifth optical ineffective area 75B of the fifth lens 75 and the sixth optical ineffective area 76B of the sixth lens 76. The abutting portion 92 surrounds an outer periphery of the annular portion 91 and abuts against an inner wall of the lens barrel 61. The second lens positioning unit 90 is positioned within the lens barrel 61 and fixes the imaging lens assembly 70 by the abutting portion 92 abutting against the inner wall of the lens barrel 61.

In other embodiments, an installing position of the second lens positioning unit 90 could be adjusted as needed. For example, the second lens positioning unit 90 could be disposed between the first lens 71 and the second lens 72, allowing the annular portion 91 of the second lens positioning unit 90 to contact between the first lens 71 and the second lens 72. Alternatively, the second lens positioning unit 90 could be installed on the first light entrance member 81, allowing the annular portion 91 of the second lens positioning unit 90 to contact either the first lens 71 or the second lens 72. In other words, the second lens positioning unit 90 could also be installed between the second lens 72 and the third lens 73, or between the third lens 73 and the fourth lens 74.

Summarizing the first embodiment to fifth embodiment described above, the optical image capturing lenses 100, 200, 300, 400, 500 could effectively block the non-imaging light from entering the image capturing lens assemblies 20, 70 through the design of the light entrance members 30, 30′, 80, so that the interference from the non-imaging light on the optical image capturing lenses 100, 200, 300, 400, 500 is reduced, thus improving image quality. Moreover, the overall dimension of each clear member 30, 30′, 80 is reduced through the light entrance members 30, 30′, 80 satisfying the TILE and TOLE conditions. This results in the miniaturization of the optical image capturing lenses 100, 200, 300, 400, 500 and enhances optical imaging quality. Additionally, the configuration of the inner edge of the light entrance holes of each light entrance members 30, 30′, 80 could be adjusted as needed. As long as the diameter of the light entrance hole of each light entrance member 30, 30′, 80 is smaller than or equal to the maximum effective diameter of each lens, the non-imaging light could be effectively blocked from passing through the lenses and the amount of the imaging light passing through each lens could be controlled.

It should be noted that in other embodiments, the number of the components and the structure of the optical image capturing lens could be adjusted according to actual needs. For example, the number of the lenses in the imaging lens assembly could be chosen to be at least one lens, or the imaging lens assembly could basically include a first lens and a second lens. The number of the light entrance members could also be chosen to be at least one, and the light entrance member could be disposed on either an object-side surface or an image-side surface of a lens, or the light entrance member could be disposed between the first lens and the second lens, which could also achieve the purpose of blocking the non-imaging light from passing through the lens. The image sensing module and the second lens positioning unit could be omitted if desired.

It must be pointed out that the embodiments described above are only some preferred embodiments of the present invention. All equivalent structures which employ the concepts disclosed in this specification and the appended claims should fall within the scope of the present invention.

What is claimed is:

1. An optical image capturing lens, comprising:
a first lens positioning unit, wherein an interior of the first lens positioning unit is hollow, and the first lens positioning unit is made of an opaque material; one end of the first lens positioning unit has an object-side opening communicating with the interior of the first lens positioning unit;
an imaging lens assembly installed within the first lens positioning unit, wherein the imaging lens assembly, along an optical axis from an object side to an image side starting from the object-side opening, comprises at least one lens and an image plane; the at least one lens has refractive power; the at least one lens has an optical effective area and an optical ineffective area; the optical effective area is surrounded by the optical ineffective area; the optical axis passes through the at least one lens via the optical effective area; the at least one lens defines a maximum effective diameter at the optical effective area; the image plane is located on one side of the at least one lens opposite to the object-side opening; and
at least one light entrance member made of an opaque material, wherein the at least one light entrance member is installed within the first lens positioning unit and is disposed on either an object-side surface, which faces the object side, or an image-side surface, which faces the image side, of the at least one lens; the at least one light entrance member surrounds the optical axis and faces the optical ineffective area; the at least one light entrance member has a light entrance hole facing the optical effective area of the at least one lens to allow the optical axis to pass through; a diameter of the light entrance hole is smaller than or equal to the maximum effective diameter of the at least one lens.

2. The optical image capturing lens as claimed in claim 1, wherein the first lens positioning unit comprises a lens barrel and a lens holder that are formed as an integrated structure; one end of the lens barrel has the object-side opening, and the lens holder is located on another end of the lens barrel opposite to the object-side opening; the imaging lens assembly and the at least one light entrance member are installed within the lens barrel.

3. The optical image capturing lens as claimed in claim 1, wherein the first lens positioning unit comprises a lens barrel and a lens holder; the lens barrel is detachably combined with the lens holder; one end of the lens barrel has the object-side opening, and the lens holder is combined with another end of the lens barrel opposite to the object-side opening; the imaging lens assembly and the at least one light entrance member are installed within the lens barrel.

4. The optical image capturing lens as claimed in claim 2, further comprising a second lens positioning unit, wherein the second lens positioning unit is made of an opaque material and is installed within the lens barrel of the first lens positioning unit; the second lens positioning unit has an annular portion and an abutting portion; the annular portion contacts the at least one lens, and the abutting portion surrounds an outer periphery of the annular portion and abuts against an inner wall of the lens barrel.

5. The optical image capturing lens as claimed in claim 3, further comprising a second lens positioning unit, wherein the second lens positioning unit is made of an opaque material and is installed within the lens barrel of the first lens positioning unit; the second lens positioning unit has an annular portion and an abutting portion; the annular portion contacts the at least one lens, and the abutting portion surrounds an outer periphery of the annular portion and abuts against an inner wall of the lens barrel.

6. The optical image capturing lens as claimed in claim 1, wherein the at least one light entrance member satisfies: 0 μm<TILE≤50 μm; TILE is a thickness of an inner peripheral edge of the at least one light entrance member corresponding to the light entrance hole.

7. The optical image capturing lens as claimed in claim 6, wherein the at least one light entrance member satisfies: 0.1 μm<TILE≤10 μm.

8. The optical image capturing lens as claimed in claim 6, wherein the at least one light entrance member has an inner annular section and an outer annular section; the inner annular section surrounds the light entrance hole, and the outer annular section surrounds an outer periphery of the inner annular section; TILE is defined as a minimum thickness of the inner annular section.

9. The optical image capturing lens as claimed in claim 8, wherein the inner annular section has an inner inclined portion sloping from the outer annular section towards the light entrance hole; the at least one light entrance member defines a horizontal reference plane; the horizontal reference plane passes through the inner annular section and the outer annular section in correspondence to the light entrance hole and is perpendicular to the optical axis; the at least one light entrance member satisfies: 10°≤ALE≤90°; ALE is an inclination angle of the inner inclined portion relative to the horizontal reference plane.

10. The optical image capturing lens as claimed in claim 9, wherein the inner annular section has a flat portion extending along the optical axis and connected to the inner inclined portion; TILE is defined as a thickness of the flat portion.

11. The optical image capturing lens as claimed in claim 8, wherein the inner annular section has a first inner inclined portion and a second inner inclined portion; the first inner inclined portion and the second inner inclined portion extend with opposite inclinations; the first inner inclined portion slopes from a top surface of the outer annular section towards the light entrance hole, and the second inner inclined portion slopes from a bottom surface of the outer annular section towards the light entrance hole; the at least one light entrance member defines a horizontal reference plane; the horizontal reference plane passes through the inner annular section and the outer annular section in correspondence to the light entrance hole and is perpendicular to the optical axis; the at least one light entrance member satisfies: 10°≤OALE≤90°; 10°≤IALE≤90°; OALE is an inclination angle of the first inner inclined portion relative to the horizontal reference plane, and IALE is an inclination angle of the second inner inclined portion relative to the horizontal reference plane.

12. The optical image capturing lens as claimed in claim 11, wherein the inner annular section has a flat portion; the flat portion extends along the optical axis and is connected to the first inner inclined portion and the second inner inclined portion; TILE is defined as a thickness of the flat portion.

13. The optical image capturing lens as claimed in claim 8, wherein a configuration of the inner annular section is trapezoidal, tapered, angular, or polygonal.

14. The optical image capturing lens as claimed in claim 8, wherein the at least one light entrance member satisfies: 0.008 mm≤TOLE≤0.2 mm; TOLE is a maximum thickness of an outer peripheral edge of the at least one light entrance member corresponding to the outer annular section.

15. The optical image capturing lens as claimed in claim 2, wherein the lens barrel has a light blocking ring surrounding the optical axis, and an inner edge of the light blocking ring surrounds to form the object-side opening; the light blocking ring faces the object-side surface of the at least one lens and corresponds to the optical ineffective area; the at least one light entrance member is disposed on the object-side surface of the at least one lens and is fixed between the at least one lens and the light blocking ring.

16. The optical image capturing lens as claimed in claim 3, wherein the lens barrel has a light blocking ring surrounding the optical axis; an inner edge of the light blocking ring surrounds to form the object-side opening; the light blocking ring faces the object-side surface of the at least one lens and corresponds to the optical ineffective area; the light entrance member is disposed on the object-side surface of the lens and is fixed between the at least one lens and the light blocking ring.

17. The optical image capturing lens as claimed in claim 15, wherein the diameter of the light entrance hole is smaller than or equal to an inner diameter of the object-side opening of the lens barrel.

18. The optical image capturing lens as claimed in claim 16, wherein the diameter of the light entrance hole is smaller than or equal to an inner diameter of the object-side opening of the lens barrel.

19. The optical image capturing lens as claimed in claim 1, wherein the at least one light entrance member satisfies: 0 μm≤CONP≤50 μm; the light entrance hole has a light entrance central axis; CONP is a distance between the light entrance central axis at the light entrance hole and the optical axis in a direction perpendicular to the optical axis.

20. The optical image capturing lens as claimed in claim 1, wherein the first lens positioning unit satisfies: 0 μm≤CONE≤50 μm; the object-side opening has an opening central axis; CONE is a distance between the opening central axis at the object-side opening and the optical axis in a direction perpendicular to the optical axis.

21. The optical image capturing lens as claimed in claim 1, wherein the optical image capturing lens satisfies: 0 μm≤CON≤50 μm; the light entrance hole has a light entrance central axis, and the object-side opening has an opening central axis; CON is a maximum distance between the light entrance central axis at the light entrance hole and the opening central axis at the object-side opening in a direction perpendicular to the optical axis.

22. The optical image capturing lens as claimed in claim 1, wherein the at least one light entrance member comprises a first light entrance member and a second light entrance member; the first light entrance member contacts the object-side surface of the at least one lens, and the second light entrance member contacts the image-side surface of the at least one lens.

23. The optical image capturing lens as claimed in claim 1, wherein a material of the at least one light entrance member is metal, plastic, carbon, PET, or polyimide (PI).

24. The optical image capturing lens as claimed in claim 1, further comprising an image sensing module, wherein the image sensing module is installed within the first lens positioning unit and is disposed correspondingly at a location on the image plane.

25. An optical image capturing lens, comprising:
a first lens positioning unit, wherein an interior of the first lens positioning unit is hollow, and the first lens positioning unit is made of an opaque material; one end of the first lens positioning unit has an object-side opening;
an imaging lens assembly installed within the first lens positioning unit, wherein the imaging lens assembly, along an optical axis from an object side to an image side starting from the object-side opening, comprises a first lens, a second lens, and an image plane; the first lens and the second lens each have refractive power; the first lens has a first optical effective area and a first optical ineffective area; the first optical effective area is surrounded by the first optical ineffective area; the second lens has a second optical effective area and a second optical ineffective area; the second optical effective area faces the first optical effective area, and the second optical effective area is surrounded by the second optical ineffective area; the image plane is located on one side of the second lens opposite to the object-side opening and the first lens;
wherein the optical axis passes through the first lens and the second lens respectively via the first optical effective area and the second optical effective area; the first lens defines a first maximum effective diameter at the first optical effective area, and the second lens defines a second maximum effective diameter at the second optical effective area; and
at least one light entrance member made of an opaque material, wherein the at least one light entrance member is installed within the first lens positioning unit; the at least one light entrance member surrounds the optical axis and is located between the first lens and second lens; the at least one light entrance member is disposed on a side of the first optical ineffective area of the first lens facing the second optical ineffective area of the second lens; the at least one light entrance member has a light entrance hole facing the first optical effective area and the second optical effective area to allow the optical axis to pass through; a diameter of the light entrance hole is smaller than or equal to the first maximum effective diameter of the first lens and is smaller than or equal to the second maximum effective diameter of the second lens.

26. The optical image capturing lens as claimed in claim 25, wherein the first lens positioning unit comprises a lens barrel and a lens holder that are formed as an integrated structure; one end of the lens barrel has the object-side opening, and the lens holder is combined with another end of the lens barrel opposite to the object-side opening; the imaging lens assembly and the at least one light entrance member are installed within the lens barrel.

27. The optical image capturing lens as claimed in claim 25, wherein the first lens positioning unit comprises a lens barrel and a lens holder; the lens barrel is detachably combined with the lens holder; one end of the lens barrel has the object-side opening, and the lens holder is combined with another end of the lens barrel opposite to the object-side opening; the imaging lens assembly and the at least one light entrance member are installed within the lens barrel.

28. The optical image capturing lens as claimed in claim 26, further comprising a second lens positioning unit, wherein the second lens positioning unit is made of an opaque material and is installed within the lens barrel of the first lens positioning unit; the second lens positioning unit has an annular portion and an abutting portion; the annular portion contacts the first lens or the second lens, and the abutting portion surrounds an outer periphery of the annular portion and abuts against an inner wall of the lens barrel.

29. The optical image capturing lens as claimed in claim 27, further comprising a second lens positioning unit, wherein the second lens positioning unit is made of an opaque material and is installed within the lens barrel of the first lens positioning unit; the second lens positioning unit has an annular portion and an abutting portion; the annular portion contacts the first lens or the second lens, and the abutting portion surrounds an outer periphery of the annular portion and abuts against an inner wall of the lens barrel.

30. The optical image capturing lens as claimed in claim 25, wherein the at least one light entrance member satisfies: 0 μm<TILE≤50 μm; TILE is a thickness of an inner peripheral edge of the at least one light entrance member corresponding to the light entrance hole.

31. The optical image capturing lens as claimed in claim 30, wherein the at least one light entrance member satisfies: 0.1 μm<TILE≤10 μm.

32. The optical image capturing lens as claimed in claim 30, wherein the at least one light entrance member has an inner annular section and an outer annular section; the inner annular section surrounds the light entrance hole, and the outer annular section surrounds an outer periphery of the inner annular section; TILE is defined as a minimum thickness of the inner annular section.

33. The optical image capturing lens as claimed in claim 32, wherein the inner annular section has an inner inclined portion sloping from the outer annular section towards the light entrance hole; the at least one light entrance member defines a horizontal reference plane; the horizontal reference plane passes through the inner annular section and the outer annular section in correspondence to the light entrance hole and is perpendicular to the optical axis; the at least one light entrance member satisfies: 10°≤ALE≤90°; ALE is an inclination angle of the inner inclined portion relative to the horizontal reference plane.

34. The optical image capturing lens as claimed in claim 33, wherein the inner annular section has a flat portion extending along the optical axis and connected to the inner inclined portion; TILE is defined as a thickness of the flat portion.

35. The optical image capturing lens as claimed in claim 32, wherein the inner annular section has a first inner inclined portion and a second inner inclined portion; the first inner inclined portion and the second inner inclined portion extend with opposite inclinations; the first inner inclined portion slopes from a top surface of the outer annular section towards the light entrance hole, and the second inner inclined portion slopes from a bottom surface of the outer annular section towards the light entrance hole; the at least one light entrance member defines a horizontal reference plane; the horizontal reference plane passes through the inner annular section and the outer annular section in correspondence to the light entrance hole and is perpendicular to the optical axis; the at least one light entrance member satisfies: 10°≤OALE≤90°; 10°≤IALE≤90°; OALE is an inclination angle of the first inner inclined portion relative to the horizontal reference plane, and IALE is an inclination angle of the second inner inclined portion relative to the horizontal reference plane.

36. The optical image capturing lens as claimed in claim 35, wherein the inner annular section has a flat portion; the flat portion extends along the optical axis and is connected to the first inner inclined portion and the second inner inclined portion; TILE is defined as a thickness of the flat portion.

37. The optical image capturing lens as claimed in claim 32, wherein the at least one light entrance member satisfies: 0.008 mm≤TOLE≤0.2 mm; TOLE is a maximum thickness of an outer peripheral edge of the at least one light entrance member corresponding to the outer annular section.

38. The optical image capturing lens as claimed in claim 32, wherein a configuration of the inner annular section is trapezoidal, tapered, angular, or polygonal.

39. The optical image capturing lens as claimed in claim 25, wherein the at least one light entrance member comprises a first light entrance member, a second light entrance member, and a third light entrance member; the first light entrance member is disposed on an object-side surface, which faces the image side, of the first lens; the second light entrance member is disposed between an image-side surface, which faces the image side, of the first lens and an object-side surface, which faces the object side, of the second lens; the third light entrance member is disposed on an image-side surface, which faces the image side, of the second lens.

40. The optical image capturing lens as claimed in claim 39, wherein the first lens positioning unit has a light blocking ring surrounding the optical axis; an inner edge of the light blocking ring surrounds to form the object-side opening; the light blocking ring faces the object-side surface of the first lens and corresponds to the first optical ineffective area;
the first light entrance member is disposed on the object-side surface of the first lens and is fixed between the first lens and the light blocking ring.

41. The optical image capturing lens as claimed in claim 40, wherein the diameter of the light entrance hole is smaller than or equal to an inner diameter of the object-side opening of the lens barrel.

42. The optical image capturing lens as claimed in claim 25, wherein the at least one light entrance member satisfies: 0 μm≤CONP≤50 μm; the light entrance hole has a light entrance central axis; CONP is a distance between the light entrance central axis at the light entrance hole and the optical axis in a direction perpendicular to the optical axis.

43. The optical image capturing lens as claimed in claim 25, wherein the first lens positioning unit satisfies: 0 μm≤CONE≤50 μm; the object-side opening has an opening central axis of the; CONE is a distance between the opening central axis at the object-side opening and the optical axis in a direction perpendicular to the optical axis.

44. The optical image capturing lens as claimed in claim 25, wherein the optical image capturing lens satisfies: 0 μm≤CON≤50 μm; the light entrance hole has a light entrance central axis, and the object-side opening has an opening central axis; CON is a maximum distance between the light entrance central axis at the light entrance hole and the opening central axis at the object-side opening in a direction perpendicular to the optical axis.

45. The optical image capturing lens as claimed in claim 25, wherein a material of the at least one light entrance member is metal, plastic, carbon, PET, or polyimide (PI).

46. The optical image capturing lens as claimed in claim 25, further comprising an image sensing module, wherein the image sensing module is installed within the first lens positioning unit and is disposed correspondingly at a location on the image plane.
